(19) United States
(12) Patent Application Publication
(10) Pub. No.: US 2024/0342603 A1
(43) Pub. Date: Oct. 17, 2024

(54) NON-TRANSITORY COMPUTER-READABLE STORAGE MEDIUM, INFORMATION PROCESSING SYSTEM, INFORMATION PROCESSING METHOD, AND INFORMATION PROCESSING APPARATUS

(71) Applicant: NINTENDO CO., LTD., Kyoto (JP)

(72) Inventors: Kazuhiro KAWAMURA, Kyoto (JP); Akira FURUKAWA, Kyoto (JP); Yuya SATO, Kyoto (JP)

(21) Appl. No.: 18/483,854

(22) Filed: Oct. 10, 2023

(30) Foreign Application Priority Data
Apr. 11, 2023 (JP) 2023-064323

(51) Int. Cl. A63F 13/56

(52) U.S. Cl. CPC A63F 13/56

(57) ABSTRACT

In an example game according to an exemplary embodiment, a plurality of objects in a first classification are placed in a virtual space. Each of the objects in the first classification have information indicating in which state of a first state and a second state the object is, and information indicating in which state of a third state and a fourth state the object is. If an object in the first classification is in the first state, the object performs a behavior relating to a type of the object. If an object in a first classification is in the first state and the third state, a first parameter is decreased, and if the first parameter decreases to a predetermined reference, the object in the first classification is changed to the second state.

### CROSS REFERENCE TO RELATED APPLICATION

This application claims priority to Japanese Patent Application No. 2023-64323 filed on Apr. 11, 2023, the entire contents of which are incorporated herein by reference.

### FIELD

An exemplary embodiment relates to a non-transitory computer-readable storage medium having stored therein a game program, an information processing system, an information processing method, and an information processing apparatus.

### BACKGROUND AND SUMMARY

Conventionally, there is a game where energy decreases in a case where a player character makes an attack using a weapon.

In the above game, however, energy decreases in a case where the player character merely uses a weapon. The management of a plurality of objects in a virtual space that perform predetermined behaviors using a parameter is not assumed.

Therefore, it is an object of an exemplary embodiment to provide a non-transitory computer-readable storage medium having stored therein a game program, an information processing system, an information processing method, and an information processing apparatus that are capable of managing the behaviors of a plurality of objects in a virtual space using a parameter in accordance with the states of the plurality of objects, and also causing an object to perform a behavior even in the state where the object is not a target of the management using the parameter.

To achieve the above object, the exemplary embodiment employs the following configurations.

### (First Configuration)

Instructions according to a first configuration, when executed, cause a computer of an information processing apparatus to execute game processing including: based on operation data, controlling a player character in accordance with any of behaviors at least including a plurality of actions and a movement in a virtual space. The game processing includes placing a plurality of objects in a first classification in the virtual space. Each object has at least information indicating in which state of a first state and a second state other than the first state the object is, information indicating in which state of a third state and a fourth state other than the third state the object is, a type, and a consumption amount for a first parameter associated with a player. The game processing includes: based on at least any of the actions, switching the first state and the second state of at least any of the objects in the first classification; based on at least any of the actions, changing at least any of the objects in the first classification in the fourth state to the third state: causing each of the objects in the first classification in the first state to continuously perform a behavior set with respect to each of the types in the virtual space: based on the consumption amount of each of the objects in the first classification in the first state and the third state, continuously decreasing the first parameter; and if the first parameter decreases to a predetermined reference, changing the object in the first classification in the first state and the third state from the first state to the second state.

Based on the above, an object in a first classification has a first state or a second state and a third state or a fourth state. If the object in the first classification is in the first state, the object performs a behavior relating to the type of the object. If the object in the first classification is in the first state and the third state, a first parameter associated with a player is decreased. If the first parameter decreases to a predetermined reference, the object in the first classification is changed to the second state. Consequently, it is possible to stop the behavior of the object in the first classification and manage the behavior of the object in the first classification based on the first parameter. If, on the other hand, the object in the first classification is in the first state and the fourth state, it is possible to cause the object in the first classification to perform the behavior without decreasing the first parameter. Consequently, it is possible to manage the behaviors of a plurality of objects in the first classification in a virtual space based on the first parameter and also cause an object in the first classification that is not a target of the management to perform a behavior.

### (Second Configuration)

According to a second configuration, in the above first configuration, the plurality of actions may include an attack action. The game processing may further include, if the attack action hits an object in the first classification, switching the first state and the second state of the object in the first classification, and further, if the object in the first classification is in the fourth state, changing the object in the first classification to the third state.

Based on the above, based on an attack action of a player character, it is possible to switch the first state and the second state of an object in the first classification and also change the object in the first classification to the third state.

### (Third Configuration)

According to a third configuration, in the above first or second configuration, the plurality of actions may include an object operation action for, using as a control target an object specified among objects in a second classification that is a classification at least including an object in the first classification, at least controlling a movement of the control target. The game processing may further include, in a case where the player character performs the object operation action on the object in the first classification as the control target, and if the control target is in the fourth state, changing the control target to the third state.

Based on the above, if an object operation action is performed on an object in the first classification, it is possible to change the object in the first classification to the third state.

### (Fourth Configuration)

According to a fourth configuration, in the above third configuration, the game processing may further include performing integration control for integrating the control target with another object in the second classification in the object operation action, thereby generating an assembly object, and if an object in the fourth state is included in an integration destination, changing the object in the fourth state to the third state.

Based on the above, it is possible to generate an assembly object by integrating a control target of the object operation action with an object in a second classification and change an object as the integration destination to the third state.

### (Fifth Configuration)

According to a fifth configuration, in the above fourth configuration, the game processing may further include, if the control target is an object in the first classification, and the integration destination is another object in the first classification or the assembly object including the other object in the first classification in the integration control in the object operation action, setting the information regarding the control target indicating in which state of the first state and the second state the control target is in to be the same as the information regarding an object in the first classification included in the integration destination.

Based on the above, in a case where an operation target is integrated with another object based on the object operation action, it is possible to match the setting of the operation target regarding in which state of the first state and the second state the operation target is to that of an object as the integration destination. For example, if the object as the integration destination is in the first state, it is possible to set the operation target to the first state. If the object as the integration destination is in the second state, it is possible to set the operation target to the second state. Consequently, it is possible to prevent an object in the first classification in the first state and an object in the first classification in the second state from being mixed together in the assembly object.

### (Sixth Configuration)

According to a sixth configuration, in the above fifth configuration, the plurality of actions may include an attack action, The game processing may further include, if the attack action hits the assembly object, switching the first state and the second state of all objects in the first classification included in the assembly object, and if an object in the fourth state is included in the assembly object, changing the object in the fourth state to the third state.

Based on the above, if the attack action of the player character hits the assembly object, it is possible to switch the first state and the second state of all the objects in the first classification included in the assembly object and change the objects in the first classification to the third state.

### (Seventh Configuration)

According to a seventh configuration, in the above fifth or sixth configuration, the objects in the second classification may include a switching object capable of entering either of an operated state where the switching object is operated by the player character and a non-operated state where the switching object is not operated by the player character. The plurality of actions may include a switching object operation action for changing the switching object to the operated state. The game processing may further include, in a case where the switching object is included in the assembly object, and if the switching object enters the operated state, setting all objects in the first classification included in the assembly object to the first state, and if the switching object enters the non-operated state, setting all the objects in the first classification included in the assembly object to the second state.

Based on the above, it is possible to switch the first state and the second state of all the objects in the first classification included in the assembly object based on an operated state of a switching object.

### (Eighth Configuration)

According to an eighth configuration, in any of the above fourth to seventh configurations, the game processing may further include, if the assembly object including a plurality of objects in the first classification of the same type is generated by the integration control of the object operation action, reducing the consumption amount set for at least any of the plurality of objects in the first classification.

Based on the above, if a plurality of objects of the same type in the first classification are included in the assembly object, it is possible to reduce the consumption amount of the objects in the first classification. Consequently, even if an assembly object including a plurality of objects of the same type in the first classification is in the first state and the third state, it is possible to reduce a decrease in the first parameter.

### (Ninth Configuration)

According to a ninth configuration, in any of the above fourth to eighth configurations, an object in the second classification may include a parameter object with which a second parameter is associated. The game processing may further include: in a case where the parameter object is included in the assembly object, and if an object in the first classification included in the assembly object is in the first state and the third state, decreasing the second parameter based on the consumption amount of each of objects in the first classification included in the assembly object; and reducing an amount of decrease in the first parameter until the second parameter decreases to a predetermined reference.

Based on the above, if a parameter object is included in the assembly object, it is possible to reduce a decrease in the first parameter by decreasing a second parameter associated with the parameter object.

### (Tenth Configuration)

According to a tenth configuration, in any of the above first to ninth configurations, the game processing may further include changing an object in the first classification of which a distance from the player character exceeds a predetermined reference to the second state.

Based on the above, if an object in the first classification moves away from a player character, it is possible to change the object in the first classification to the second state, and it is possible to prevent the first parameter from continuing to decrease.

### (Eleventh Configuration)

According to an eleventh configuration, in any of the above fourth to ninth configurations, the game processing may further include, if distances between the player character and all objects in the second classification included in the assembly object exceed a predetermined reference, changing an object in the first classification included in the assembly object to the second state.

Based on the above, if the assembly object moves away from the player character, it is possible to change an object in the first classification included in the assembly object to the second state, and it is possible to prevent the first parameter from continuing to decrease.

### (Twelfth Configuration)

According to a twelfth configuration, in any of the above first to eleventh configurations, the game processing may further include, in a case where the first parameter is less than a predetermined upper limit value, and if an object in the first classification in the first state and the third state is not present in the virtual space, continuously increasing the first parameter to the upper limit value.

Based on the above, if an object in the first classification in the first state and the third state is not present, it is possible to recover the first parameter.

### (Thirteenth Configuration)

According to a thirteenth configuration, in any of the above first to twelfth configurations, the plurality of actions may include: a combined weapon generation action for integrating an object in the second classification with a weapon object, thereby generating a combined weapon object; and a weapon attack action for making an attack using the weapon object or the combined weapon object. The game processing may further include, if the weapon attack action using the combined weapon object including an object in the first classification is performed, decreasing the first parameter by a predetermined amount.

Based on the above, even if an attack action using a combined weapon object including an object in the first classification is performed, it is possible to decrease the first parameter.

### (Fourteenth Configuration)

According to a fourteenth configuration, in any of the above first to thirteenth configurations, the game processing may further include: controlling a non-player character in the in the virtual space; and if the non-player character uses an object in the first classification in the third state, setting the object in the first classification to the fourth state.

Based on the above, if a non-player character uses an object in the first classification, it is possible to set the object in the first classification to the fourth state.

Another configuration may be an information processing system, or may be an information processing apparatus, or may be an information processing method.

According to the exemplary embodiment, it is possible to manage the behaviors of a plurality of objects in a first classification in a virtual space using a first parameter and also cause an object in the first classification in a state where the object is not a target of the management to perform a behavior.

These and other objects, features, aspects and advantages of the exemplary embodiments will become more apparent from the following detailed description of the exemplary embodiments when taken in conjunction with the accompanying drawings.

### BRIEF DESCRIPTION OF THE DRAWINGS

FIG. 1 is an example non-limiting diagram showing a game system;

FIG. 2 is an example non-limiting block diagram showing an exemplary internal configuration of the main body apparatus 2:

FIG. 3 is an example non-limiting diagram showing an example of a game image displayed in a case where a game according to an exemplary embodiment is executed:

FIG. 4 is an example non-limiting diagram showing examples of action objects:

FIG. 5 is an example non-limiting diagram showing an example of a game image displayed when an operable object 31 is being operated based on an object operation action of a player character PC:

FIG. 6 is an example non-limiting diagram showing an example of a game image displayed when a fan object 31a is being moved based on the object operation action:

FIG. 7 is an example non-limiting diagram showing an example of an assembly object generated based on the object operation action and an example of an airplane object 40 including the fan object 31a and a wing object 31d:

FIG. 8 is an example non-limiting diagram showing an example of another assembly object generated based on the object operation action and an example of a four-wheel vehicle object 41:

FIG. 9 is an example non-limiting diagram showing an example of a game image displayed when the player character PC rides on the four-wheel vehicle object 41 and starts moving the four-wheel vehicle object 41:

FIG. 10 is an example non-limiting diagram showing an example of a game image displayed when a predetermined time elapses from the state shown in FIG. 9;

FIG. 11 is an example non-limiting diagram showing an example of a game image displayed when a remote attack of the player character PC hits the four-wheel vehicle object 41, and the four-wheel vehicle object 41 starts moving:

FIG. 12 is an example non-limiting diagram showing an example of a game image displayed when a predetermined time elapses from the state shown in FIG. 11;

FIG. 13 is an example non-limiting diagram showing an example of a game image displayed when the four-wheel vehicle object 41 including a battery object 31h moves:

FIG. 14 is an example non-limiting diagram showing an example of a game image displayed when wheel objects 31b included in a four-wheel vehicle object 51 are in an operating state and a non-possessed state:

FIG. 15 is an example non-limiting diagram showing an example of a game image displayed when the four-wheel vehicle object 51 in the non-possessed state changes to a possessed state in a case where an attack action of the player character PC hits the four-wheel vehicle object:

FIG. 16 is an example non-limiting diagram showing an example of a game image displayed when the player character PC is equipped with a combined weapon object 37 obtained by combining a sword object 36 and a flamethrower object 31h:

FIG. 17 is an example non-limiting diagram showing an example of a game image displayed when the player character PC performs an attack action using the combined weapon object 37:

FIG. 18 is an example non-limiting diagram showing an example of a game image displayed before a wheel object 31b is connected to a three-wheel vehicle object 52 that is moving, based on the object operation action:

FIG. 19 is an example non-limiting diagram showing an example of a game image displayed after the wheel object 31b is connected:

FIG. 20 is an example non-limiting diagram showing an example of data stored in a memory of the main body apparatus 2 during the execution of game processing;

FIG. 21 is an example non-limiting flow chart showing an example of game processing executed by a processor 21;

FIG. 22 is an example non-limiting flow chart showing an example of an object state switching process in step S104;

FIG. 23 is an example non-limiting flow chart showing an example of an object operation action-related process in step S200;

FIG. 24 is an example non-limiting flow chart showing an example of a control yoke-related process in step S201;

FIG. 25 is an example non-limiting flow chart showing an example of an attack-related process in step S202; and

FIG. 26 is an example non-limiting flow chart showing an example of an energy consumption/recovery process in step S105.

### DETAILED DESCRIPTION OF NON-LIMITING EXAMPLE EMBODIMENTS

### (Game System Configuration)

A game system according to an example of an exemplary embodiment is described below. FIG. 1 is a diagram showing an exemplary game system. An example of a game system 1 according to the exemplary embodiment includes a main body apparatus (an information processing apparatus; which functions as a game apparatus main body in the exemplary embodiment) 2, a left controller 3, and a right controller 4. The main body apparatus 2 is an apparatus for performing various processes (e.g., game processing) in the game system 1. The left controller 3 includes a plurality of buttons 5L (up, down, left, and right direction keys) and an analog stick 6L as exemplary operation units through which a user provides input. The right controller 4 includes a plurality of buttons 5R (an A-button, a B-button, an X-button, and a Y-button) and an analog stick 6R as exemplary operation units through which the user provides input. An L-button 7L is provided on an upper surface of the left controller 3, and an R-button 7R is provided on an upper surface of the right controller 4.

Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2, or the main body apparatus 2, the left controller 3, and the right controller 4 may be separated from one another, when being used. It should be noted that hereinafter, the left controller 3 and the right controller 4 will occasionally be referred to collectively as a “controller”.

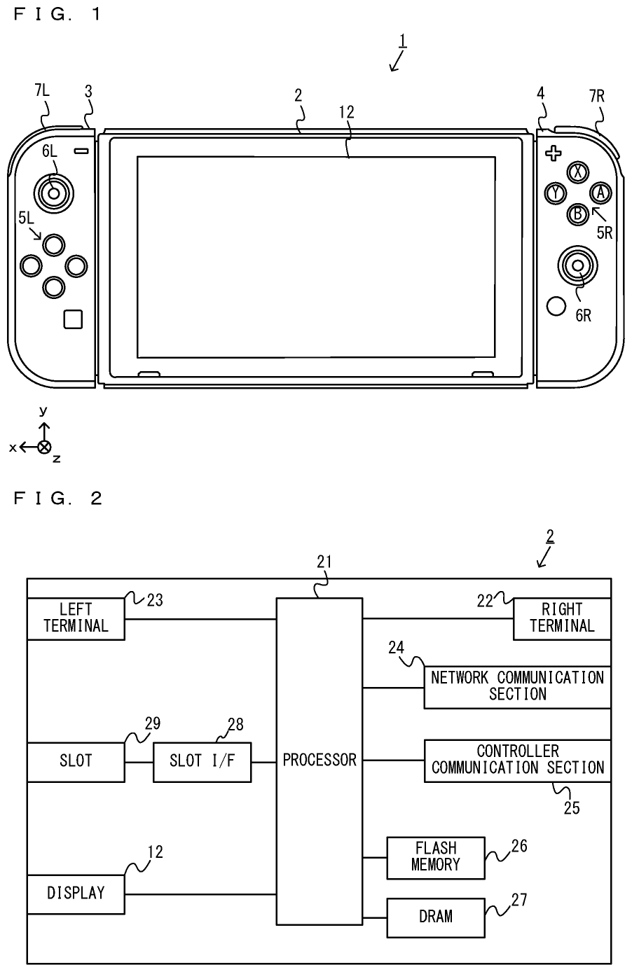

FIG. 2 is a block diagram showing an example of the internal configuration of the main body apparatus 2. As shown in FIG. 2, the main body apparatus 2 includes a processor 21. The processor 21 is an information processing section for executing various types of information processing (e.g., game processing) to be executed by the main body apparatus 2, and for example, includes a CPU (Central Processing Unit) and a GPU (Graphics Processing Unit). Note that the processor 21 may be configured only by a CPU, or may be configured by a SoC (System-on-a-Chip) that includes a plurality of functions such as a CPU function and a GPU function. The processor 21 executes an information processing program (e.g., a game program) stored in a storage section (specifically, an internal storage medium such as a flash memory 26, an external storage medium attached to the slot 29, or the like), thereby performing the various types of information processing.

Further, the main body apparatus 2 also includes a display 12. The display 12 displays an image generated by the main body apparatus 2. In the exemplary embodiment, the display 12 is a liquid crystal display device (LCD). The display 12, however, may be a display device of any type. The display 12 is connected to the processor 21. The processor 21 displays a generated image (e.g., an image generated by executing the above information processing) and/or an externally acquired image on the display 12.

Further, the main body apparatus 2 includes a left terminal 23, which is a terminal for the main body apparatus 2 to perform wired communication with the left controller 3, and a right terminal 22, which is a terminal for the main body apparatus 2 to perform wired communication with the right controller 4.

Further, the main body apparatus 2 includes a flash memory 26 and a DRAM (Dynamic Random Access Memory) 27 as examples of internal storage media built into the main body apparatus 2. The flash memory 26 and the DRAM 27 are connected to the processor 21. The flash memory 26 is a memory mainly used to store various data (or programs) to be saved in the main body apparatus 2. The DRAM 27 is a memory used to temporarily store various data used for information processing.

The main body apparatus 2 includes a slot 29. The slot 29 is so shaped as to allow a predetermined type of storage medium to be attached to the slot 29. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of a game application or the like) used by the main body apparatus 2 and/or a program (e.g., a game program or the like) executed by the main body apparatus 2.

The main body apparatus 2 includes a slot interface (hereinafter abbreviated as “I/F”) 28. The slot I/F 28 is connected to the processor 21. The slot I/F 28 is connected to the slot 29, and in accordance with an instruction from the processor 21, reads and writes data from and to the predetermined type of storage medium (e.g., a dedicated memory card) attached to the slot 29.

The processor 21 appropriately reads and writes data from and to the flash memory 26, the DRAM 27, and each of the above storage media, thereby performing the above information processing.

The main body apparatus 2 includes a network communication section 24. The network communication section 24 is connected to the processor 21. The network communication section 24 performs wired or wireless communication with an external apparatus via a network. In the exemplary embodiment, as a first communication form, the network communication section 24 connects to a wireless LAN and communicates with an external apparatus, using a method compliant with the Wi-Fi standard. Further, as a second communication form, the network communication section 24 wirelessly communicates with another main body apparatus 2 of the same type, using a predetermined communication method (e.g., communication based on a unique protocol or infrared light communication). It should be noted that the wireless communication in the above second communication form achieves the function of enabling so-called “local communication” in which the main body apparatus 2 can wirelessly communicate with another main body apparatus 2 placed in a closed local network area, and the plurality of main body apparatuses 2 directly communicate with each other to transmit and receive data.

The main body apparatus 2 includes a controller communication section 25. The controller communication section 25 is connected to the processor 21. The controller communication section 25 wirelessly communicates with the left controller 3 and/or the right controller 4. The communication method between the main body apparatus 2 and the left controller 3 and the right controller 4 is optional. In the exemplary embodiment, the controller communication section 25 performs communication compliant with the Bluetooth (registered trademark) standard with the left controller 3 and with the right controller 4.

The processor 21 is connected to the left terminal 23 and the right terminal 22. When performing wired communication with the left controller 3, the processor 21 transmits data to the left controller 3 via the left terminal 23 and also receives operation data from the left controller 3 via the left terminal 23. Further, when performing wired communication with the right controller 4, the processor 21 transmits data to the right controller 4 via the right terminal 22 and also receives operation data from the right controller 4 via the right terminal 22. As described above, in the exemplary embodiment, the main body apparatus 2 can perform both wired communication and wireless communication with each of the left controller 3 and the right controller 4.

It should be noted that, in addition to the elements shown in FIG. 2, the main body apparatus 2 includes a battery that supplies power and an output terminal for outputting images and audio to a display device (e.g., a television) separate from the display 12.

### (Overview of Game)

Next, a game according to the exemplary embodiment is described. In the game according to the exemplary embodiment, a player character PC controlled based on an operation input provided by a player is placed in a three-dimensional virtual space (a game space).

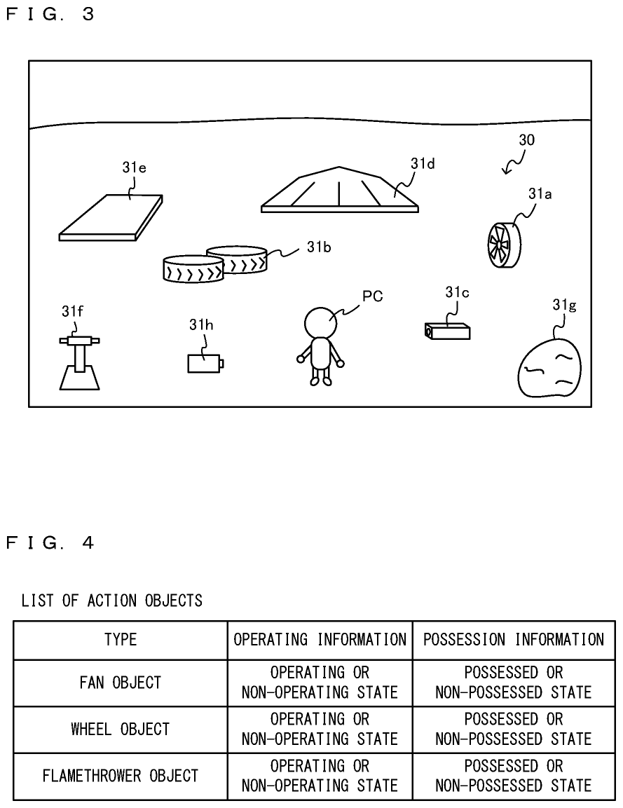

FIG. 3 is a diagram showing an example of a game image displayed in a case where the game according to the exemplary embodiment is executed. As shown in FIG. 3, the player character PC and a plurality of operable objects 31 (e.g., 31a to 31h) are placed on a ground 30 in the virtual space. Although not shown in FIG. 3, non-player characters (e.g., an enemy character, a company character of the player character PC, and the like) controlled by the processor 21 are placed in addition to the player character PC in the virtual space.

At least any one of the plurality of operable objects 31 may be placed in advance in the virtual space. At least any one of the plurality of operable objects 31 may be placed in the virtual space in accordance with an operation input provided by the player. If the player character PC defeats an enemy character, at least any one of the plurality of operable objects 31 may be placed in the virtual space.

Based on an operation input provided to the controller (3 or 4), the player character PC moves in the virtual space or performs any of a plurality of actions in the virtual space.

For example, the player character PC performs an attack action as one of the plurality of actions. Specifically, the player character PC is equipped with a weapon object owned by the player character PC, and based on an operation input provided by the player, performs an attack action relating to the weapon object with which the player character PC is equipped. For example, the player character PC is equipped with a weapon object for a proximity attack (e.g., a sword, a spear, an axe, or the like), and based on an operation input provided by the player, performs an attack action of swinging the weapon object. The player character PC is also equipped with a weapon object for a remote attack (e.g., a bow-and-arrow object), and in accordance with an operation input provided by the player, performs an attack action of discharging the arrow object to the virtual space.

The player character PC also performs an object operation action as one of the plurality of actions. For example, the object operation action is the action of remotely operating an operable object 31 in front of the player character PC. The operable object 31 is an object that can be a target of the object operation action of the player character PC. The player character PC operates the operable object 31 based on the object operation action.

Specifically, based on an operation input provided by the player, any of the plurality of operable objects placed in the virtual space is set as a control target of the object operation action. Based on the object operation action, the movement of the control target is controlled in the virtual space. Based on the object operation action, the orientation of the control target is also controlled. Based on the object operation action, the control target is also connected to another operable object placed in the virtual space and integrated with the other operable object. Consequently, an assembly object obtained by combining a plurality of operable objects is generated. An operation on each operable object 31 based on the object operation action will be described below.

Each operable object 31 may be able to move in the virtual space based not only on the object operation action, but also on another action (e.g., the action of lifting the object) of the player character PC. Such another action may be able to move the operable object 31, but may be prevented from integrating the operable object with another operable object as in the object operation action.

In the virtual space, an object that cannot be operated based on the object operation action (here referred to as a “non-operation object”) is also placed. Examples of the non-operation object include terrain objects such as a rock, a mountain, a building, and a ground fixed to the virtual space.

As shown in FIG. 3, for example, the plurality of operable objects 31 include a fan object 31a, a wheel object 31b, and a flamethrower object 31c.

Each of the fan object 31a, the wheel object 31b, and the flamethrower object 31c is an object that performs a behavior relating to the type of the object in an operating state, and is an object that produces an effect relating to the type. Here, among the operable objects 31, an object that performs a behavior relating to the type of the object in the virtual space is referred to as an “action object”. The action object is an example of an object in a first classification. Here, for example, “performing a behavior in the virtual space” may include the generation of a wind, the generation of a propulsive force, the generation of a flame, the generation of light, the generation of a vibration, the generation of a beam, explosion, and the like in the virtual space.

FIG. 4 is a diagram showing examples of the action objects. As shown in FIG. 4, a type, operating information, and possession information are set for each of the action objects.

The operating information is information indicating whether the action object is in a state where the action object is operating (an operating state) or a non-operating state. In the operating state, the action object performs a behavior relating to the type of the action object.

The possession information is information indicating whether the action object is in a state where the action object is possessed by the player character PC (a possessed state) or a non-possessed state. The non-possessed state is a state where the action object is not possessed by the player character PC, and for example, includes a state where the action object is possessed by an enemy character and a state where the action object is not possessed by any character. Although the details will be described below, when the action object is in the operating state and the possessed state, the action object consumes the energy possessed by the player character PC. The action objects may include an object that does not consume the possessed energy even in the operating state and the possessed state.

Specifically, the fan object 31a is an object representing a fan. The fan object 31a can generate a wind in the virtual space when in the operating state, and can fly an object (e.g., an enemy character) placed in the virtual space by the wind. The fan object 31a also generates a propulsive force in a direction opposite to the direction of the wind.

The wheel object 31b is an object representing a wheel. The wheel object 31b rotates in a direction set in advance when in the operating state, and generates a propulsive force by the rotation.

The flamethrower object 31c is an object representing a flamethrower and generates a flame in a predetermined direction when in the operating state. The player character PC can burn an object (e.g., a tree or grass) in the virtual space or attack an enemy character using the flame.

In addition to the action objects shown in FIG. 4, various other action objects may be prepared. For example, as action objects, a lamp object that emits light when in the operating state, a beam generation object that generates a beam when in the operating state, and the like may be prepared.

As shown in FIG. 3, the plurality of operable objects 31 also include a wing object 31d, a board object 31e, a control yoke object 31f, a rock object 31g, and a battery object 31h.

The wing object 31d is an object for flying in the sky. In a case where the wing object 31d moves at a predetermined velocity or more in the virtual space, the wing object 31d generates an upward force in the virtual space. The board object 31e is a planar object, and for example, can be used as the body of a vehicle.

The control yoke object 31f is an object for, if the control yoke object 31f is configured as a part of an assembly object, controlling the movement of the assembly object. For example, the control yoke object 31f is an example of a switching object, and based on an operation input provided by the player, changes an action object included in the assembly object to the operating state or controls the moving direction of the assembly object.

The rock object 31g is an object representing a rock. The battery object 31h is an object representing a battery. The details of the battery object 31h will be described below.

The wing object 31d, the board object 31e, the control yoke object 31f, the rock object 31g, and the battery object 31h are objects different from the above action objects, and are objects that do not each have operating information indicating whether the object is in the operating state or the non-operating state. Here, such an operable object 31 different from the action objects is referred to as a “non-action object”. The “non-action object” is an object that does not perform a behavior relating to the type of the object, and is an object that does not consume the energy possessed by the player character PC.

The non-action object may have possession information indicating whether the non-action object is in the possessed state or the non-possessed state, or may not have such possession information. The non-action object may have operating information indicating whether the non-action object is in the operating state or the non-operating state. In this case, even if the non-action object is set to the operating state, the non-action object does not generate a propulsive force, or generate a flame, or generate light as in the action objects. That is, even if the non-action object is set to the operating state, the non-action object does not perform a behavior relating to the type of the object.

### (Operation on Operable Object Based on Object Operation Action)

As described above, in the game according to the exemplary embodiment, it is possible to move an operable object 31 based on the object operation action of the player character PC. It is also possible to generate an assembly object including a plurality of operable objects 31 based on the object operation action.

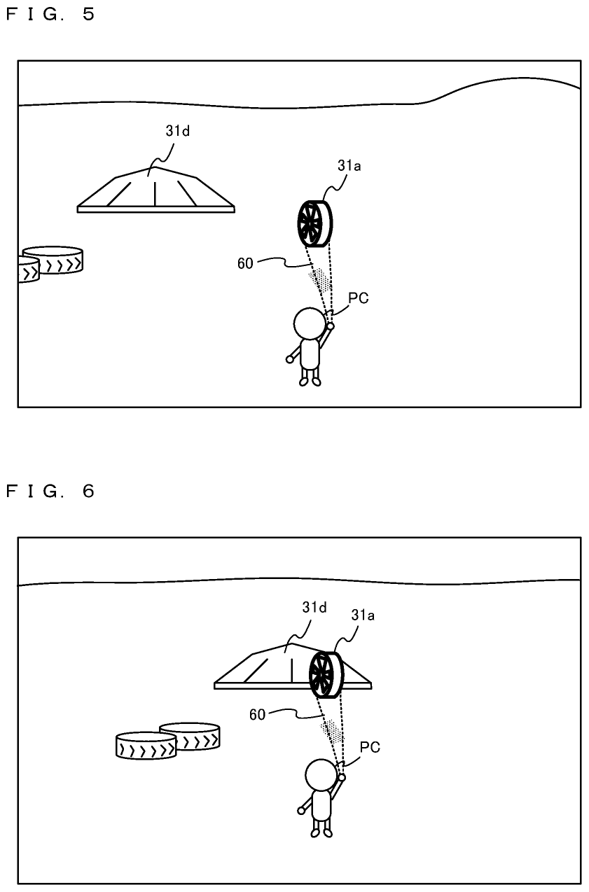

FIG. 5 is a diagram showing an example of a game image displayed when an operable object 31 is being operated based on the object operation action of the player character PC.

For example, when an operable object 31 is in front of the player character PC (or near the fixation point of a virtual camera), and if a predetermined operation input is provided, the player character PC performs the object operation action on the operable object 31. For example, in accordance with a predetermined selection operation, the fan object 31a is selected among the plurality of operable objects 31 placed in the virtual space. Then, if a predetermined operation input is provided, as shown in FIG. 5, the selected fan object 31a becomes a control target, and the game enters the state where the object operation action is being performed on the control target. In the state where the object operation action is being performed on the fan object 31a, the fan object 31a is in the state where the fan object 31a is off the ground, and is also in a display form different from normal. An effect image 60 indicating that the object operation action is being performed is also displayed.

At this time, if the player character PC moves in accordance with a movement operation input (e.g., a direction operation input to the analog stick 6L of the left controller 3) provided by the player, the fan object 31a also moves. For example, if a direction operation input is provided to the analog stick 6R of the right controller 4, the direction of the player character PC may change, and the fan object 31a may also move in the virtual space so that the fan object 31a is located in front of the player character PC. For example, the fan object 31a may be moved or rotated in accordance with key operations on the buttons 5L.

FIG. 6 is a diagram showing an example of a game image displayed when the fan object 31a is being moved based on the object operation action. As shown in FIG. 6, for example, while the fan object 31a is being operated based on the object operation action, and if the player character PC moves toward the wing object 31d, the fan object 31a also moves in the same direction by following the player character PC. In a case where the fan object 31a and the wing object 31d satisfy a predetermined connection condition (e.g., the distance between the fan object 31a and the wing object 31d is less than a threshold), and if a connection instruction (e.g., the pressing of the A-button) is given by the player, the fan object 31a is connected to the wing object 31d. Consequently, an assembly object including a plurality of operable objects 31 is generated. Here, as the assembly object, an airplane object 40 including the fan object 31a and the wing object 31d is generated.

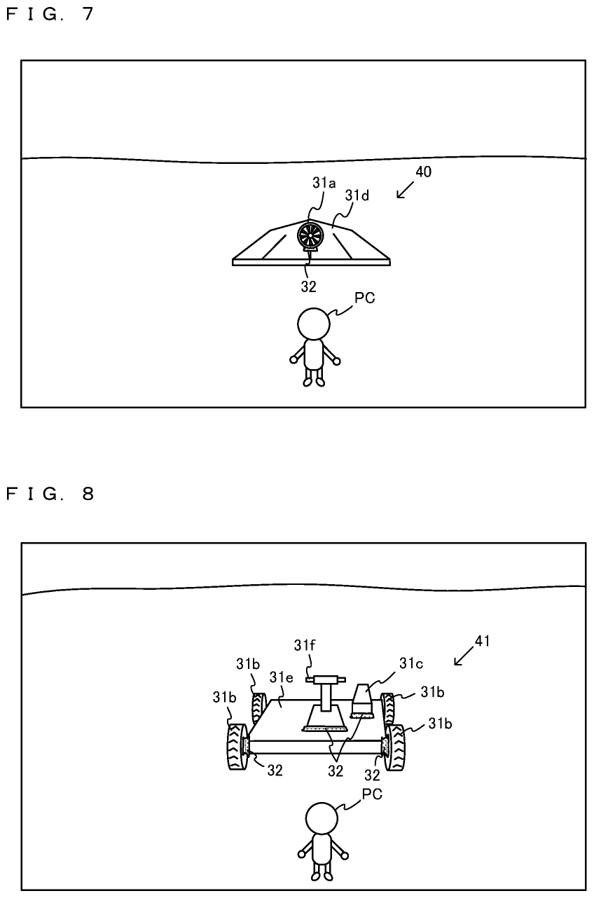

FIG. 7 is a diagram showing an example of the assembly object generated based on the object operation action and an example of the airplane object 40 including the fan object 31a and the wing object 31d.

As shown in FIG. 7, a connection object 32 is placed between the fan object 31a and the wing object 31d. The connection object 32 is an object indicating that the operable objects 31 are connected together, and is an object that fixes the positional relationship between the operable objects 31. The plurality of operable objects 31 included in the assembly object are connected together by connection objects 32.

The assembly object including the plurality of operable objects 31 performs an action in a unified manner in the virtual space. For example, if the fan object 31a included in the airplane object 40 changes from the non-operating state to the operating state, the fan object 31a generates a propulsive force. This propulsive force of the fan object 31a is also transmitted to the wing object 31d connected to the fan object 31a, and the airplane object 40 including the fan object 31a and the wing object 31d starts moving. For example, by hitting the airplane object 40 with the attack action of the player character PC, it is possible to change the fan object 31a included in the airplane object 40 from the non-operating state to the operating state.

After the airplane object 40 starts moving, and if the velocity of the airplane object 40 exceeds a predetermined value, the airplane object 40 floats in the air by the lift force of the wing object 31d and flies in the virtual space. The player character PC can fly in the virtual space on the airplane object 40.

FIG. 8 is a diagram showing an example of another assembly object generated based on the object operation action and an example of a four-wheel vehicle object 41.

As shown in FIG. 8, the four-wheel vehicle object 41 includes the board object 31e, four wheel objects 31b, the control yoke object 31f, and the flamethrower object 31c. For example, based on the object operation action, the four wheel objects 31b are connected to side surfaces of the board object 31e in order. Each of the board object 31e and the four wheel objects 31b is connected by a connection object 32. Further, based on the object operation action, the control yoke object 31f is connected to an upper surface of the board object 31e. The board object 31e and the control yoke object 31f are connected by a connection object 32. Based on the object operation action, the flamethrower object 31c is also connected to the upper surface of the board object 31e. The board object 31e and the flamethrower object 31c are connected by a connection object 32. Consequently, the four-wheel vehicle object 41 as an assembly object that performs an action in a unified manner is generated.

If the wheel objects 31b are in the operating state, each of the wheel objects 31b rotates in a direction set in advance. The four wheel objects 31b are connected to the board object 31e so that the four wheel objects 31b rotate in the same direction. In this case, if the four wheel objects 31b enter the operating state, each of the four wheel objects 31b generates a propulsive force in the same direction, and the four-wheel vehicle object 41 starts moving on the ground in the virtual space. The player character PC on the four-wheel vehicle object 41 can move faster than walking on the ground in the virtual space. If the player character PC is operating the control yoke object 31f, the moving direction of the four-wheel vehicle object 41 can be controlled based on a direction operation input (e.g., a direction operation input to the analog stick 6L) provided by the player.

Here, if the attack action of the player character PC hits an action object, the action object changes from the non-operating state to the operating state or changes from the operating state to the non-operating state. Specifically, if the attack action of the player character PC hits a sole action object, the sole action object changes from the operating state to the non-operating state or changes from the non-operating state to the operating state. If the attack action of the player character PC hits any object in an assembly object, all the action objects included in the assembly object change from the operating state to the non-operating state or change from the non-operating state to the operating state. If the attack action of the player character PC hits an action object, regardless of whether the attack action is a proximity attack or a remote attack, the action object changes from the operating state to the non-operating state or changes from the non-operating state to the operating state. For example, if the attack action of the player character PC hits the fan object 31a or the wing object 31c in the airplane object 40, the fan object 31a included in the airplane object 40 changes from the non-operating state to the operating state. For example, if the attack action of the player character PC hits the four-wheel vehicle object 41, the four wheel objects 31b and the flamethrower object 31c included in the four-wheel vehicle object 41 change from the non-operating state to the operating state.

In a case where the control yoke object 31f is included in an assembly object, and if the player character PC starts operating the control yoke object 31f, all the action objects included in the assembly object enter the operating state. Specifically, in a case where the control yoke object 31f is included in an assembly object, the player character PC can ride on the assembly object and move on the assembly object. For example, if the player character PC comes close to the control yoke object 31f placed on the assembly object, the player character PC starts operating the control yoke object 31f. Consequently, all the action objects included in the assembly object change to the operating state. While the player character PC is operating the control yoke object 31f, and if an operation input for ending the operation is provided by the player, the player character PC ends the operation on the control yoke object 31f and moves away from the control yoke object 31f. Consequently, all the action objects included in the assembly object enter the non-operating state. For example, if the player character PC operates the control yoke object 31f on the four-wheel vehicle object 41, the four wheel objects 31b and the flamethrower object 31c enter the operating state. If the player character PC ends the operation on the control yoke object 31f, all the action objects included in the assembly object enter the non-operating state.

The operating state and the non-operating state of an action object in an assembly object are switched by the attack action, regardless of whether or not the player character PC is on the assembly object. In contrast, the operating state and the non-operating state of an action object in an assembly object are switched using the control yoke object 31f when the player character PC is substantially on the assembly object. In a case where the attack action of the player character PC hits an assembly object, and if an action object included in the assembly object is in the non-possessed state, the action object is changed to the possessed state. In a case where the player character PC operates the control yoke object 31f in an assembly object, and if an action object included in the assembly object is in the non-possessed state, the action object is changed to the possessed state.

### (Case Where Player Character Steers Four-Wheel Vehicle Object on Four-Wheel Vehicle Object)

A description is given below of control performed when the player character PC steers the four-wheel vehicle object 41 using the control yoke object 31f on the four-wheel vehicle object 41.

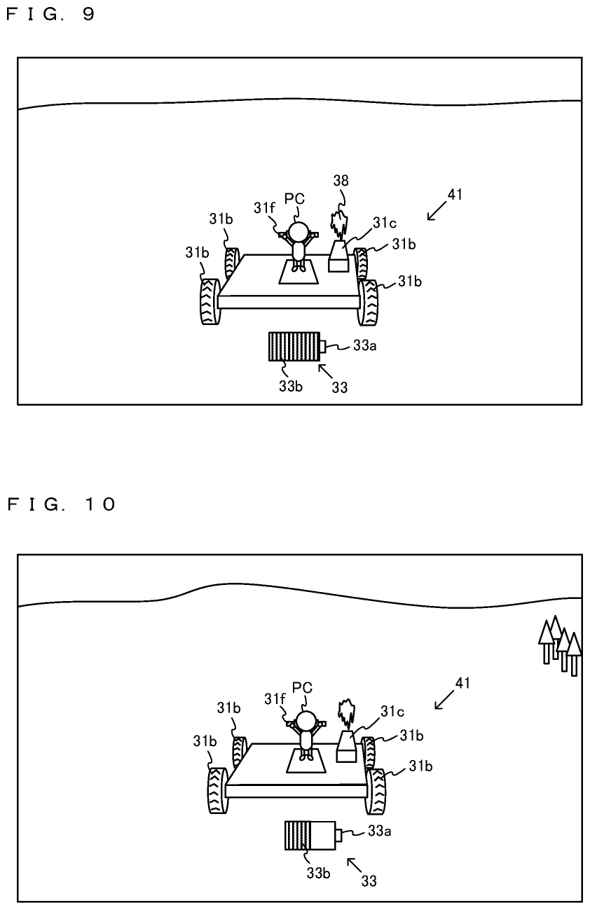

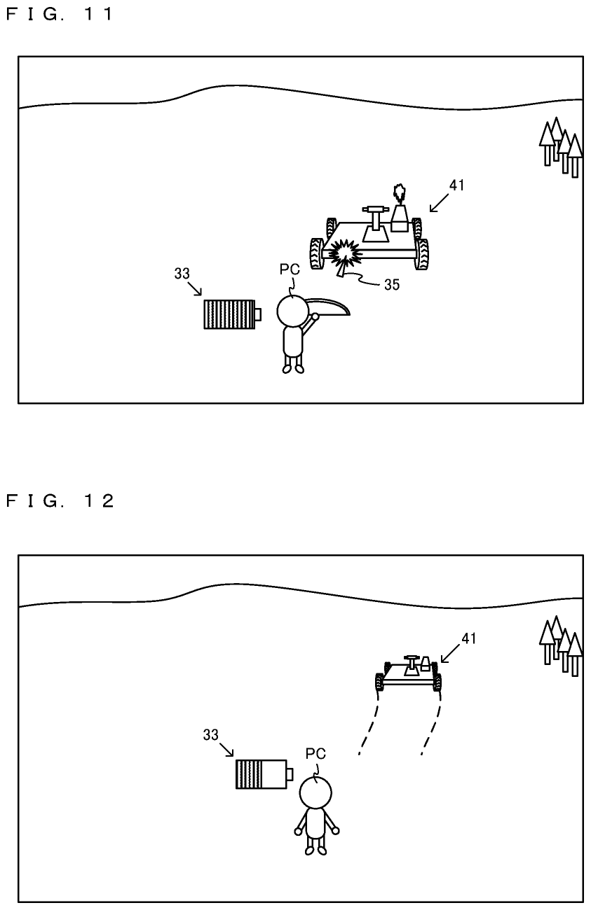

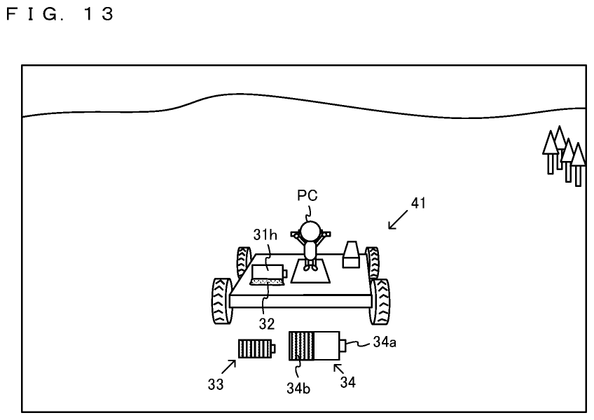

FIG. 9 is a diagram showing an example of a game image displayed when the player character PC rides on the four-wheel vehicle object 41 and starts moving the four-wheel vehicle object 41. FIG. 10 is a diagram showing an example of a game image displayed when a predetermined time elapses from the state shown in FIG. 9.

For example, if the player character PC comes close to the control yoke object 31f on the four-wheel vehicle object 41, the player character PC starts operating the control yoke object 31f. At this time, the four wheel objects 31b and the flamethrower object 31c enter the operating state and the possessed state, and the four-wheel vehicle object 41 starts moving by the propulsive forces of the four wheel objects 31b. The flamethrower object 31c also throws a flame 38.

As shown in FIG. 9, energy display 33 indicating the current amount of energy possessed by the player character PC is displayed. The amount of possessed energy is a parameter associated with the player character PC and is the amount of energy possessed by the player character PC. For example, the energy display 33 includes an outside image 33a representing a battery and an inside gauge image 33b indicating the amount of energy possessed by the player character PC. In FIG. 9, the gauge image 33b has the maximum length and indicates that the amount of energy possessed by the player character PC has an upper limit value.

While the action objects included in the four-wheel vehicle object 41 are in the operating state and the possessed state, the amount of energy possessed by the player character PC continuously decreases. Specifically, each of the four wheel objects 31b in the operating state and the possessed state decreases the amount of energy possessed by the player character PC. The flamethrower object 31c in the operating state and the possessed state also decreases the amount of energy possessed by the player character PC.

As shown in FIG. 10, if a predetermined time elapses after the four-wheel vehicle object 41 starts moving, the amount of possessed energy decreases to a predetermined value. In FIG. 10, the gauge image 33b has a length about half the maximum length and indicates that the amount of energy possessed by the player character PC is about half the upper limit value.

If the amount of energy possessed by the player character PC decreases to a predetermined reference value (e.g., zero), the wheel objects 31b change from the operating state to the non-operating state, and the four-wheel vehicle object 41 loses its propulsive force. Consequently, the four-wheel vehicle object 41 stops. The flamethrower object 31c also changes from the operating state to the non-operating state, and the throwing of the flame 38 stops. Even if the four-wheel vehicle object 41 loses its propulsive force, the four-wheel vehicle object 41 may continue to move by inertia for a while.

For the action objects, energy consumption amounts in the operating state and the possessed state are set. For example, “3” is set as the consumption amount for the fan object 31a. “2” is set as the consumption amount for the wheel object 31b. “1” is set as the consumption amount for the flamethrower object 31c.

All the action objects in the operating state and the possessed state present in the virtual space decrease the amount of energy possessed by the player character PC. Thus, the greater the number of action objects in the operating state and the possessed state is, the greater the amount of decrease in the amount of possessed energy per unit time is. For example, the amount of decrease in the amount of possessed energy by the four-wheel vehicle object 41, which includes four wheel objects 31b, is greater than that by a two-wheel vehicle object, which includes two wheel objects 31b. For example, if an action object in the operating state and the possessed state or an assembly object including an action object in the operating state and the possessed state is present in addition to the four-wheel vehicle object 41 shown in FIG. 10, the amount of possessed energy is decreased based on the consumption amount set for each action object.

If a plurality of action objects of the same type are included in the same assembly object, an energy saving setting may be made for the action objects of the same type. If the energy saving setting is made for the action objects, the energy consumption amounts are smaller than the normal consumption amounts set in advance for the action objects. For example, if the normal consumption amount of the wheel object 31b is “2”, the total consumption amount of the four wheel objects 31b included in an assembly object is “8” if the energy saving setting is not made. However, the energy saving setting is made for the four wheel objects 31b, whereby, for example, the total consumption amount of the four wheel objects 31b is “5” (in this case, the consumption amount per wheel object 31b is “1.25”). Consequently, even if a plurality of action objects of the same type are included in an assembly object, it is possible to prevent the amount of possessed energy from rapidly decreasing.

As described above, if an action object is in the operating state and the possessed state, the amount of energy possessed by the player character PC decreases. If the amount of possessed energy reaches zero, the action object enters the non-operating state. If an action object in the operating state and the possessed state is not present in the virtual space, the amount of energy possessed by the player character PC recovers in accordance with the lapse of time. If the amount of possessed energy reaches zero, an action object in the possessed state may be controlled not to be set to the operating state until the amount of possessed energy recovers to the upper limit value.

(Case where Player Character Moves Four-Wheel Vehicle Object without being on Four-Wheel Vehicle Object)

Next, a description is given of control performed when the player character PC moves the four-wheel vehicle object 41 without being on the four-wheel vehicle object 41.

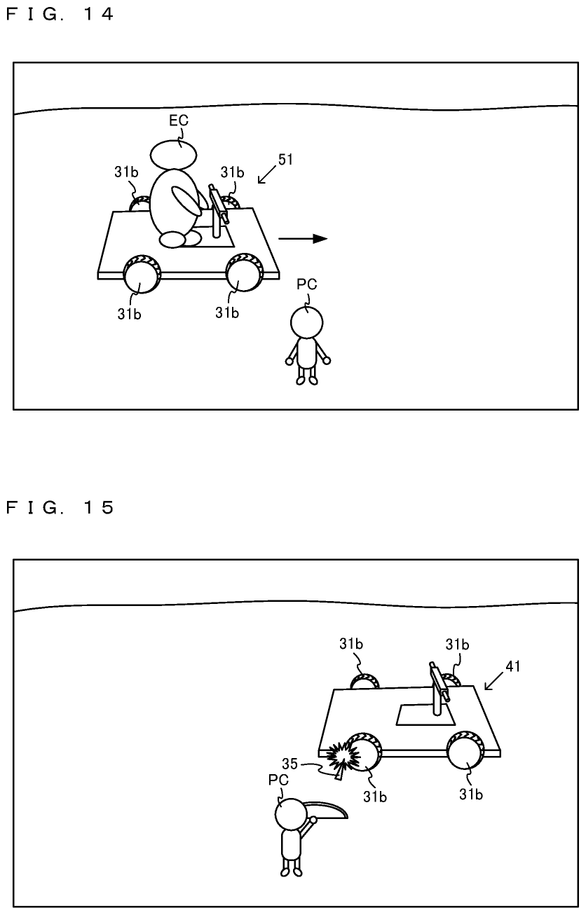

FIG. 11 is a diagram showing an example of a game image displayed when the remote attack of the player character PC hits the four-wheel vehicle object 41, and the four-wheel vehicle object 41 starts moving. FIG. 12 is a diagram showing an example of a game image displayed when a predetermined time elapses from the state shown in FIG. 11.

As shown in FIG. 11, a case is assumed where the player character PC makes a remote attack (an attack action of flying an arrow 35) based on an operation input provided by the player in the state where the player character PC is away from the four-wheel vehicle object 41. If the remote attack hits the four-wheel vehicle object 41, all the action objects included in the four-wheel vehicle object 41 enter the operating state and the possessed state. In this case, as shown in FIG. 11, the four-wheel vehicle object 41 starts moving in the state where the player character PC is not on the four-wheel vehicle object 41. At this time, the energy display 33 is displayed.

Even in the state where the player character PC is not on the four-wheel vehicle object 41, while the action objects in the four-wheel vehicle object 41 are in the operating state and the possessed state, the amount of energy possessed by the player character PC continuously decreases. As shown in FIG. 12, if a predetermined time elapses after the four-wheel vehicle object 41 starts moving, the amount of possessed energy decreases to a predetermined value, and the four-wheel vehicle object 41 moves away from the player character PC.

Here, even if the amount of energy possessed by the player character PC does not reach zero, but if the four-wheel vehicle object 41 moves a predetermined distance away from the player character PC, the action objects included in the four-wheel vehicle object 41 enter the non-operating state. Specifically, if the distances between the player character PC and all the objects (action objects and non-action objects) included in the four-wheel vehicle object 41 exceed a predetermined threshold, the action objects included in the four-wheel vehicle object 41 enter the non-operating state. If the distance between the player character PC and an action object included in the four-wheel vehicle object 41 exceeds the predetermined threshold, all the action objects included in the four-wheel vehicle object 41 may be set to the non-operating state. If the distances between the player character PC and all the non-action objects included in the four-wheel vehicle object 41 exceed the predetermined threshold, the action objects included in the four-wheel vehicle object 41 may be set to the non-operating state.

Here, the above “predetermined threshold” regarding the distances from the player character PC may be fixed, or may be variable in accordance with the scene of the game. For example, in a first scene, if an assembly object moves a first distance away from the player character PC, an action object included in the assembly object may enter the non-operating state. In a second scene, if an assembly object moves a second distance away from the player character PC, an action object included in the assembly object may enter the non-operating state. In a particular scene, no matter how far away an action object is from the player character PC, the action object may maintain the operating state. The “predetermined threshold” regarding the distances from the player character PC may differ in accordance with the type of the action object.

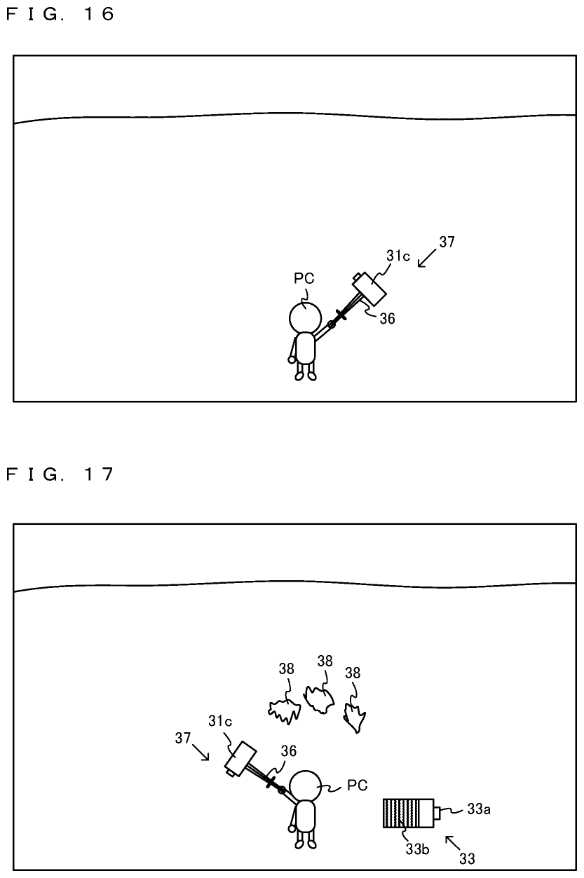

FIG. 13 is a diagram showing an example of a game image displayed when the four-wheel vehicle object 41 including the battery object 31h moves.

As shown in FIG. 13, based on the object operation action, for example, the battery object 31h is connected to the board object 31e included in the four-wheel vehicle object 41.

In a case where the battery object 31h is connected to the four-wheel vehicle object 41, and if the four-wheel vehicle object 41 is in the operating state and the possessed state, second energy display 34 is displayed in addition to the above energy display 33. The second energy display 34 indicates the remaining amount of energy of the connected battery object 31h. Specifically, for example, the second energy display 34 includes an outside image 34a representing a battery and an inside gauge image 34b indicating the remaining amount of energy of the battery object 31h. In FIG. 13, the gauge image 34b has a length about half the maximum length and indicates that the remaining amount of energy of the connected battery object 31h is about half the upper limit value.

If the four-wheel vehicle object 41 including the battery object 31h is in the operating state and the possessed state, the energy of the battery object 31h is preferentially consumed, and if the remaining amount of energy of the battery object 31h reaches a predetermined reference (e.g., zero), the energy possessed by the player character PC is consumed. That is, until the remaining amount of energy of the battery object 31h reaches zero, the amount of energy possessed by the player character PC does not decrease. If the remaining amount of energy of the battery object 31h reaches zero, the amount of energy possessed by the player character PC starts decreasing.

Specifically, when an action object included in an assembly object to which the battery object 31h is connected is in the operating state and the possessed state, the remaining amount of energy of the battery object 31h is decreased. For example, a case is assumed where another assembly object including an action object (e.g., the airplane object 40 in FIG. 7) is present in the virtual space in addition to the four-wheel vehicle object 41 shown in FIG. 13. Even if the fan object 31b included in the airplane object 40 is in the operating state and the possessed state, the remaining amount of energy of the battery object 31h included in the four-wheel vehicle object 41 does not decrease due to the operating of the fan object 31b. That is, the remaining amount of energy of the battery object 31 decreases due to the operating of the assembly object to which the battery object 31h is connected, but does not decrease due to the operating of another action object or an action object included in another assembly object. Thus, it can be said that the battery object 31 is an energy source dedicated to an assembly object to which the battery object 31h is connected.

In contrast, the amount of energy possessed by the player character PC is an energy source common to all the action objects in the operating state and the possessed state in the virtual space and decreases by all the action objects in the operating state and the possessed state. For example, in a case where the four-wheel vehicle object 41 (FIG. 13) and the airplane object 40 (FIG. 7) are present in the virtual space, and after the remaining amount of energy of the battery object 31h reaches zero, the amount of possessed energy decreases due to the operating of both the four-wheel vehicle object 41 and the airplane object 40.

### (Case Where Non-Possessed Four-Wheel Vehicle Object Moves)

Next, a case is described where a four-wheel vehicle object in the non-possessed state moves.

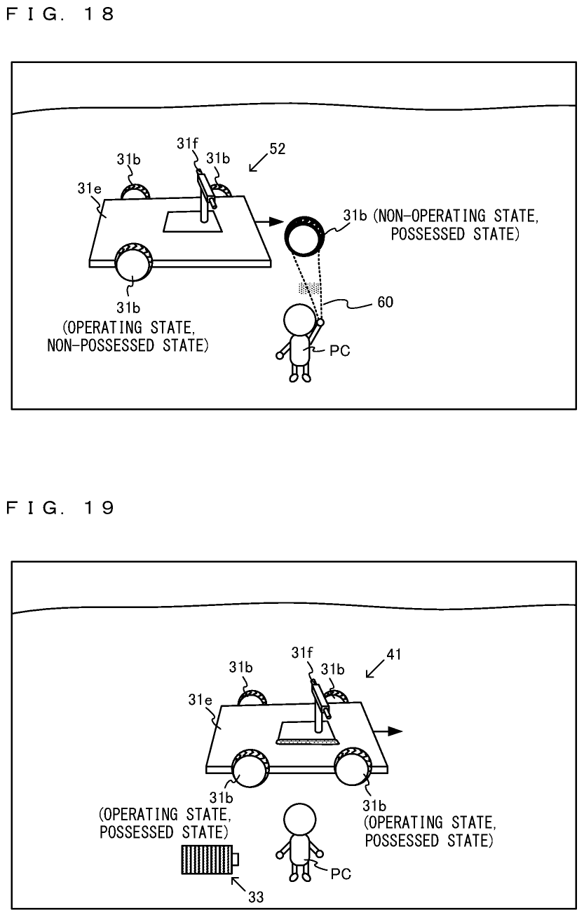

FIG. 14 is a diagram showing an example of a game image displayed when wheel objects 31b included in a four-wheel vehicle object 51 are in the operating state and the non-possessed state.

If an assembly object is generated by the object operation action of the player character PC, the assembly object enters the possessed state. If, however, the assembly object generated by the object operation action is operated by an enemy character EC (see FIG. 14), for example, the assembly object changes from the possessed state to the non-possessed state. A sole action object placed in advance in the virtual space is in the non-possessed state. In the virtual space, an assembly object in the non-possessed state may be placed in advance.

As shown in FIG. 14, even if action objects included in a four-wheel vehicle object are in the non-possessed state (e.g., in the state where the action objects are possessed by the enemy character EC), the action objects included in the four-wheel vehicle object can enter the operating state. For example, if the player character PC is not on a four-wheel vehicle object in the possessed state, and the enemy character EC operates the four-wheel vehicle object on the four-wheel vehicle object, the four-wheel vehicle object enters the non-possessed state. Alternatively, a four-wheel vehicle object initially possessed by the enemy character EC may be placed in the virtual space.

Here, a four-wheel vehicle object in the non-possessed state is referred to as a “four-wheel vehicle object 51” to distinguish the four-wheel vehicle object from the above “four-wheel vehicle object 41” in the possessed state.

As shown in FIG. 14, if action objects included in the four-wheel vehicle object 51 in the non-possessed state are in the operating state, the four-wheel vehicle object 51 moves. In this case, the energy display 33 is not displayed, and the amount of energy possessed by the player character PC does not decrease, no matter how much the four-wheel vehicle object 51 moves. That is, if wheel objects 31b included in the four-wheel vehicle object 51 are in the operating state and the non-possessed state, the wheel objects 31b generate propulsive forces, but do not decrease the amount of energy possessed by the player character PC.

FIG. 15 is a diagram showing an example of a game image displayed when the four-wheel vehicle object 51 in the non-possessed state changes to the possessed state in a case where the attack action of the player character PC hits the four-wheel vehicle object.

Even when neither of the player character PC and the enemy character EC is on the four-wheel vehicle object 51, the four-wheel vehicle object 51 in the operating state and the non-possessed state moves in the virtual space. Also in this case, the amount of energy possessed by the player character PC does not decrease, and the energy display 33 is not displayed, either.

As shown in FIG. 15, if the attack action of the player character PC hits the four-wheel vehicle object 51 in the operating state and the non-possessed state, the wheel objects 31b included in the four-wheel vehicle object 51 change from the operating state to the non-operating state. At this time, the wheel objects 31b also change from the non-possessed state to the possessed state. That is, if the attack action of the player character PC hits the four-wheel vehicle object 51 in the non-possessed state, the four-wheel vehicle object 51 changes to the four-wheel vehicle object 41 in the possessed state. Then, for example, if the attack action of the player character PC hits the four-wheel vehicle object 41 again, the wheel objects 31b included in the four-wheel vehicle object 41 change from the non-operating state to the operating state, and the four-wheel vehicle object 41 moves. In this case, the energy display 33 is displayed, and the amount of energy possessed by the player character PC decreases in accordance with the lapse of time.

In the above description, an example is shown where the amount of energy possessed by the player character decreases in a case where an assembly object is in the operating state and the possessed state. However, even if a sole action object is in the operating state and the possessed state, the amount of possessed energy decreases. For example, if the attack action of the player character PC hits the sole flamethrower object 31c placed in the virtual space, the flamethrower object 31c enters the operating state and the possessed state. If the flamethrower object 31c enters the operating state, a flame is thrown, and the amount of possessed energy decreases.

### (Energy Consumption Due to Use of Combined Weapon Object)

In the game according to the exemplary embodiment, a combined weapon object obtained by combining an object placed in the virtual space and a weapon object with which the player character PC is equipped is generated by a combined weapon generation action of the player character PC.

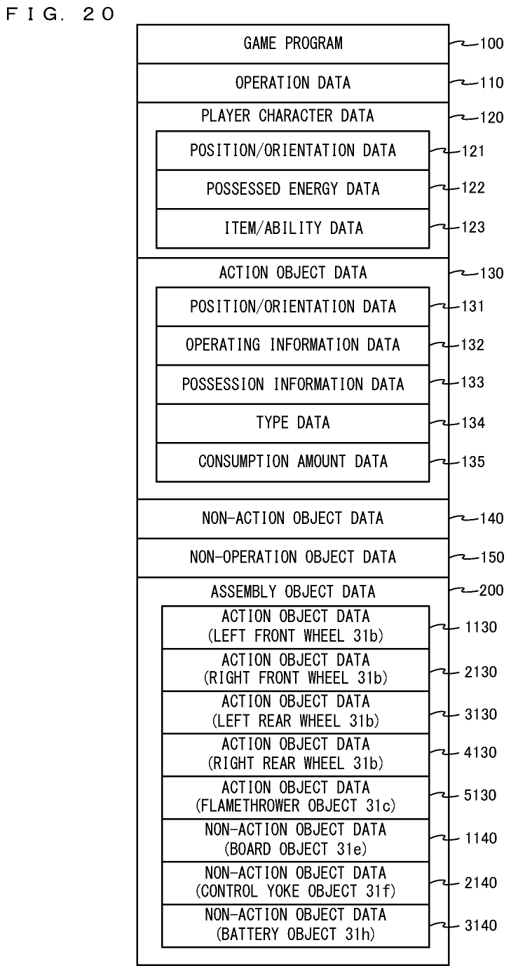

FIG. 16 is a diagram showing an example of a game image displayed when the player character PC is equipped with a combined weapon object 37 obtained by combining a sword object 36 and the flamethrower object 31c. FIG. 17 is a diagram showing an example of a game image displayed when the player character PC performs an attack action using the combined weapon object 37.

For example, when the player character PC is equipped with the sword object 36, and if a combining instruction is given, the combined weapon object 37 obtained by combining the flamethrower object 31c placed in the virtual space and the sword object 36 is generated.

The combined weapon object 37 may be generated based on polygon data of the two objects. That is, the combined weapon object 37 may be generated based on polygon data of the sword object 36 with which the player character PC is equipped and polygon data of the flamethrower object 31c placed in the virtual space. Alternatively, the combined weapon object 37 may be prepared in advance as polygon data. That is, polygon data of the sword object 36 with which the player character PC is equipped, polygon data of the flamethrower object 31c placed in the virtual space, and polygon data of the combined weapon object 37 may be prepared in advance. Before a combining instruction is given, the sword object 36 is placed at the position of the hand of the player character PC, and the flamethrower object 31c is placed on the ground in the virtual space. If a combining instruction is given, the sword object 36 and the flamethrower object 31c may be erased, and the combined weapon object 37 may be placed at the position of the hand of the player character PC.

As shown in FIG. 17, when the player character PC is equipped with the combined weapon object 37, and if an operation input for an attack action is provided, the player character PC performs an attack action of swinging the combined weapon object 37. At this time, a flame 38 is temporarily thrown. If an attack action is performed using the normal sword object 36 other than the combined weapon object 37, the flame 38 is not thrown. If the flame 38 is thrown, the energy display 33 is displayed, and the amount of energy possessed by the player character PC decreases. Specifically, if the attack action is performed once using the combined weapon object 37, the flamethrower object 31c is temporarily in the operating state, and the amount of possessed energy is decreased by a consumption amount relating to the single attack action. Every time the attack action using the combined weapon object 37 is performed, the amount of possessed energy is decreased by a predetermined amount.

As described above, if an attack action is performed using a combined weapon object obtained by combining an action object and a weapon object, the action object is temporarily in the operating state. At this time, the amount of possessed energy is decreased by a consumption amount relating to the action object. For example, if an attack action is performed using a combined weapon object obtained by combining a weapon object and the fan object 31a, the fan object 31a is temporarily in the operating state, and a wind is generated in the virtual space. With the operating of the fan object 31a, the amount of energy possessed by the player character PC is decreased by a consumption amount relating to the fan object 31a.

A combined weapon object obtained by combining a weapon object with which the player character PC is equipped instead of the sword object 36 and an action object placed in the virtual space may be generated. A combined object obtained by combining not only a weapon object but also an object with which the player character PC is equipped (e.g., a protective gear object) and an action object placed in the virtual space may be generated. If the player character PC performs an action using the combined object, the action object may be temporarily in the operating state, and the amount of energy possessed by the player character PC may be decreased.

### (Change in State Based on Object Operation Action)

Next, a description is given of a change in the state of an action object based on the object operation action. FIG. 18 is a diagram showing an example of a game image displayed before a wheel object 31b is connected to a three-wheel vehicle object 52 that is moving, based on the object operation action. FIG. 19 is a diagram showing an example of a game image displayed after the wheel object 31b is connected.

As shown in FIG. 18, for example, a three-wheel vehicle object 52 including the board object 31e, three wheel objects 31b, and the control yoke object 31f are moving in the virtual space. The three-wheel vehicle object 52 is in the non-possessed state. That is, the three wheel objects 31b included in the three-wheel vehicle object 52 are in the operating state and the non-possessed state. A case is assumed where a wheel object 31b is further connected to the three-wheel vehicle object 52 by the object operation action.

Specifically, if the player character PC performs the object operation action on a wheel object 31b in the non-operating state and the non-possessed state placed in the virtual space, the wheel object 31b becomes a control target of the object operation action. At this time, the wheel object 31b as the control target enters the possessed state. In this state, as shown in FIG. 18, the wheel object 31b in the non-operating state and the possessed state as the control target is brought close to the three-wheel vehicle object 52 in the operating state and the non-possessed state. When the three-wheel vehicle object 52 and the wheel object 31b as the control target have a predetermined positional relationship, and if a connection instruction is given by the player, the wheel object 31b as the control target is connected to the three-wheel vehicle object 52. Consequently, the four-wheel vehicle object 41 is generated (FIG. 19).

As shown in FIG. 19, if the wheel object 31b as the control target is connected to the three-wheel vehicle object 52 based on the object operation action, the operating information regarding the wheel object 31b as the control target is set to be the same as the operating information regarding an action object included in the assembly object as the integration destination. Specifically, if the three wheel objects 31b included in the three-wheel vehicle object 52 as the integration destination are in the operating state, the wheel object 31b as the control target (to be integrated) changes to the operating state.

The possession information regarding the assembly object as the integration destination is also changed. Specifically, when the wheel object 31b as the control target is integrated, the three wheel objects 31b included in the three-wheel vehicle object 52 as the integration destination change to the possessed state. Consequently, the states of the action objects included in the assembly object become the same as each other, and the generated four-wheel vehicle object 41 enters the operating state and the possessed state. If the four-wheel vehicle object 41 is in the operating state and the possessed state, the energy display 33 is displayed, and the amount of possessed energy decreases as described above.

As described above, if an action object is set as a control target of the object operation action, the action object changes to the possessed state while maintaining the operating information. If integration control for integrating an action object as a control target with another action object or an assembly object is performed based on the object operation action, the other action object or an action object included in the assembly object is changed to the possessed state while maintaining the operating information. The same applies to a case where a non-action object is integrated based on the object operation action. That is, if integration control for integrating a non-action object as a control target with another action object or an assembly object is performed based on the object operation action, the other action object or an action object included in the assembly object is changed to the possessed state. The player character can lift or move an action object or an assembly object by another action other than the object operation action. Even if such another action is performed on an action object or an assembly object, the action object or the assembly object is not changed to the possessed state. Thus, even if the action object or the assembly object is in the operating state, the amount of energy possessed by the player character PC does not decrease. Even if such another action is performed on an action object or an assembly object, the action object or the assembly object may be changed to the possessed state.

As described above, it is possible to change an action object as a control target of the object operation action to the possessed state. In a case where a control target is connected to another object based on the object operation action, it is possible to change an action object included in the integration destination to the possessed state, and it is possible to change all the action objects included in an assembly object to be generated to the possessed state.

If integration control for integrating an action object as a control target with another action object or an assembly object is performed based on the object operation action, the operating information regarding the action object as the control target is set to be the same as the operating information regarding the other action object or an action object included in the assembly object as the integration destination. That is, if an action object included in the integration destination is in the operating state, all the action objects included in the assembly object after the integration are set to the operating state. If an action object included in the integration destination is in the non-operating state, all the action objects included in the assembly object after the integration are set to the non-operating state.

Consequently, while an assembly object is being created based on the object operation action, it is possible to prevent an action object in the operating state and an action object in the non-operating state from being mixed together, prevent the assembly object from performing an unexpected behavior, and make it easy for the player to assemble the assembly object. The operating information regarding a control target is matched to that regarding the integration destination, whereby, for example, in a case where the control target in the operating state is integrated with an assembly object at a stop, it is possible to prevent the assembly object from entering the operating state. In a case where a control target in the non-operating state is integrated with an assembly object in the operating state, it is also possible to prevent the assembly object from stopping.

As described above, in the game according to the exemplary embodiment, for each of the plurality of action objects placed in the virtual space, the operating information indicating whether the action object is in the operating state or the non-operating state, and the possession information indicating whether the action object is in the possessed state or the non-possessed state are set. If the action object is in the operating state, the action object continuously performs a behavior relating to the type of the object. If the action object is in the operating state and the possessed state, the amount of possessed energy related to the player character PC is decreased. If the amount of possessed energy decreases to a predetermined reference, the action object is set to the non-operating state.

Consequently, it is possible to cause the plurality of action objects in the possessed state placed in the virtual space to simultaneously operate, and it is also possible to manage the operating of the plurality of action objects based on the amount of possessed energy related to the player character PC. Even when an action object is not in the possessed state, it is possible to cause the action object to operate. In this case, it is possible to prevent the amount of possessed energy from decreasing.

In a particular scene of the game, even if an action object is in the operating state and the possessed state, the amount of energy possessed by the player character PC may not decrease. In this case, in the particular scene, the action object can maintain the operating state.

### (Data Used in Game Processing)

Next, the details of game processing regarding the above game are described. First, data used in the game processing is described. FIG. 20 is a diagram showing an example of data stored in a memory of the main body apparatus 2 during the execution of the game processing.

As shown in FIG. 20, the memory (the DRAM 27, the flash memory 26, or the external storage medium) of the main body apparatus 2 stores a game program 100, operation data 110, player character data 120, action object data 130, non-action object data 140, non-operation object data 150, and assembly object data 200. As well as these pieces of data, various pieces of data used in game processing (e.g., data regarding an enemy character and the like) are stored in the memory.

The game program 100 is a program for executing the game processing described below. The game program is stored in advance in the external storage medium attached to the slot 29 or the flash memory 26, and when the game is executed, is loaded into the DRAM 27. The game program may be acquired from another apparatus via a network (e.g., the Internet).

The operation data 110 is data transmitted from the left controller 3 and the right controller 4 to the main body apparatus 2. The controllers 3 and 4 repeatedly transmit the operation data 110 to the main body apparatus 2 at predetermined time intervals (e.g., 1/200-second intervals).

The player character data 120 is data regarding the player character PC. The player character data 120 includes position/orientation data 121 indicating the position and the orientation in the virtual space of the player character PC, possessed energy data 122 indicating the amount of possessed energy, and item/ability data 123. The player character data 120 also includes data regarding the shape, the external appearance, and the like of the player character PC.

The item/ability data 123 includes data regarding items owned by the player character PC (a weapon object, a protective gear object, other items, and the like) and data regarding the ability of the player character PC (the ability to perform an action, e.g., the ability to perform the above object operation action, the ability to perform the combined weapon generation action, or the like). The item/ability data 123 also includes data indicating with which item the player character PC is currently equipped and which ability is currently selected. The item/ability data 123 may include data regarding an operable object that is not placed in the virtual space and is owned by the player character PC. That is, at least any one of the plurality of operable objects may be stored as the item/ability data 123, and the stored operable object may be placed in the virtual space in accordance with an operation input provided by the player.

The action object data 130 is data regarding the action objects (e.g., 31a to 31c and the like) among the operable objects 31 placed in the virtual space. The action object data 130 is stored with respect to each action object. The action object data 130 includes position/orientation data 131, operating information data 132, possession information data 133, type data 134, and consumption amount data 135.

The position/orientation data 131 is data regarding the position and the orientation in the virtual space of the action object.

The operating information data 132 is data indicating the operating information and is data indicating whether the action object is in the operating state or the non-operating state.

The possession information data 133 is data indicating the possession information and is data indicating whether the action object is in the possessed state where the action object is possessed by the player character PC or the non-possessed state where the action object is not possessed by the player character PC.

The type data 134 is data indicating the type of the action object. For example, the type data 134 includes data regarding the shape and the external appearance of the action object, data regarding the mass of the action object, and data regarding the behavior of the action object in a case where the action object is in the operating state (e.g., in a case where the action object generates a propulsive force, data regarding the magnitude of the propulsive force, the direction of the propulsive force, and the like).

The consumption amount data 135 is data regarding the energy consumption amount set for the action object and data regarding energy consumed per frame time in a case where the action object is in the operating state and the possessed state.

The non-action object data 140 is data regarding the non-action objects (e.g., 31d to 31h and the like) among the operable objects 31 placed in the virtual space. The non-action object data 140 is stored with respect to each non-action object. Although not shown in the figures, similarly to the action object data 130, the non-action object data 140 also includes at least position/orientation data regarding the position and the orientation of the non-action object and type data indicating the type of the non-action object. The non-action object data 140 may include the above possession information data.

The non-operation object data 150 is data regarding non-operation objects placed in the virtual space (objects representing a rock, a mountain, a building, a ground, and the like fixed to the virtual space). The non-operation object data 150 is stored with respect to each non-operation object. The non-operation object data 150 includes data regarding the position and the orientation of the non-operation object, data regarding the type of the non-operation object, and data regarding the shape and the external appearance of the non-operation object.

The assembly object data 200 is data regarding assembly objects placed in the virtual space (e.g., the airplane object 40, the four-wheel vehicle object 41, and the like). The assembly object data 200 is stored with respect to each assembly object. FIG. 20 shows the assembly object data 200 indicating the four-wheel vehicle object 41 as an example of the assembly objects. For example, the assembly object data 200 includes pieces of action object data (1130, 2130, 3130, and 4130) indicating the four wheel objects 31b (a left front wheel, a right front wheel, a left rear wheel, and a right rear wheel) of the four-wheel vehicle object 41. The assembly object data 200 also includes action object data 5130 indicating the flamethrower object 31c. The pieces of action object data included in the assembly object data 200 have data similar to that of the action object data 130. The assembly object data 200 also includes three pieces of non-action object data (1140, 2140, and 3140). The non-action object data 1140 is data indicating the board object 31e as the body of the four-wheel vehicle object 41. The non-action object data 2140 is data indicating the control yoke object 31f. The non-action object data 3140 is data indicating the battery object 31h.

Although not shown in the figures, the assembly object data 200 includes the possession information regarding the entirety of the assembly object. This possession information regarding the entirety of the assembly object indicates whether the assembly object is in the possessed state or the non-possessed state. The assembly object data 200 may also include the operating information regarding the entirety of the assembly object. The assembly object data 200 also includes data indicating the position and the orientation in the assembly object of each of the operable objects forming the assembly object. The assembly object data 200 may also include data regarding the mass, the position of the center of gravity, the moving velocity, the moving direction, and the like of the entirety of the assembly object.

### (Details of Game Processing)

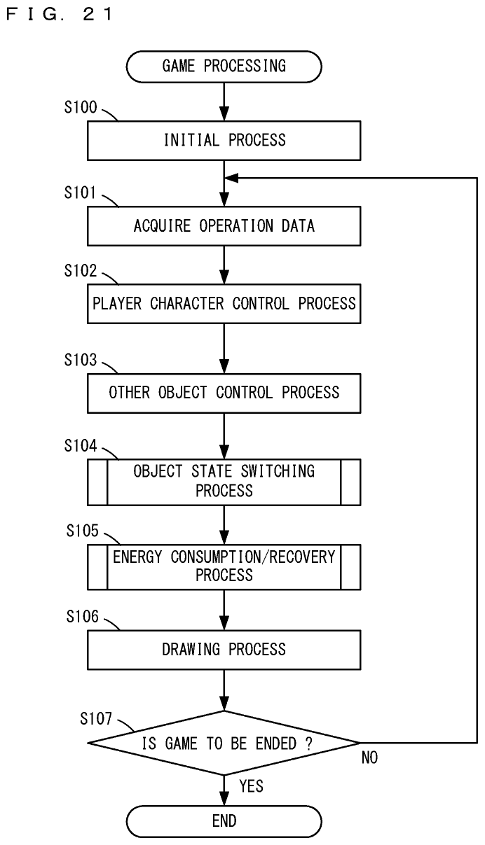

Next, the details of game processing performed by the main body apparatus 2 are described. FIG. 21 is a flow chart showing an example of game processing executed by the processor 21.

As shown in FIG. 21, if game processing is started, the processor 21 executes an initial process (step S100). Specifically, the processor 21 sets the virtual space and places the player character PC, the plurality of operable objects 31, the non-operation objects, the enemy characters EC, and the like in the virtual space.

Next, the processor 21 acquires operation data transmitted from the controllers and stored in the memory (step S101). The operation data includes data relating to operations on the buttons, the analog sticks, and the like of the left and right controllers. Hereinafter, the processor 21 repeatedly executes the processes of steps S101 to S107 at predetermined frame time intervals (e.g., 1/60 second intervals).

Subsequently, based on the operation data, the processor 21 performs a player character control process (step S102). Here, in accordance with an operation input to the controllers, the processor 21 controls the player character PC in the virtual space. Specifically, in step S102, based on the operation data, for example, the movement of the player character PC is controlled, the player character PC performs an attack action, the player character PC performs the object operation action, or the player character PC operates the control yoke object 31f.

For example, if a movement operation input (e.g., a direction operation input to the analog stick 6L of the controller 3) is given, in step S102, the processor 21 controls the movement of the player character PC. Specifically, the processor 21 moves the player character PC in the virtual space in a direction relating to the movement operation input. The processor 21 makes physical calculations based on the moving direction and the moving velocity of the player character PC, a force applied to the player character PC, a collision with another object, and the like, calculates the movement (the moving direction and the amount of movement) of the player character PC relating to a single frame, and updates the position of the player character PC. If the player character PC is on a movable object (e.g., an assembly object capable of moving, such as an airplane object or a four-wheel vehicle object), the processor 21 updates the position of the player character PC based on the movement of the movable object. Consequently, the player character PC moves in the virtual space.

If an operation input for an attack action is provided, in step S102, the processor 21 causes the player character PC to start an attack action. For example, if the player character PC is equipped with a weapon object, the processor 21 causes the player character PC to start an attack action using the weapon object. If the player character PC is equipped with a combined weapon object obtained by combining an action object (e.g., the flamethrower object 31c), the processor 21 causes the player character PC to start an attack action using the combined weapon object. The attack action is performed over a plurality of frames. After the attack action is started, the processor 21 advances an animation relating to the attack action by a single frame every time step S102 is executed.

In step S102, the processor 21 performs a process regarding the object operation action. Specifically, in accordance with a selection operation of the player (e.g., the pressing of the L-button), the processor 21 selects any of the plurality of operable objects 31 (a sole operable object or an operable object included in an assembly object). If an operable object 31 is selected, further in accordance with a predetermined operation input (e.g., the pressing of the A-button), the processor 21 causes the player character PC to start the object operation action. Specifically, the processor 21 reproduces a start animation of the object operation action, and advances the animation by a single frame every time step S102 is executed. After the start animation ends, the game enters the state where, using the selected operable object 31 as a control target, the object operation action on the control target is being performed (the control target is being operated) (see FIG. 5).

In the state where the object operation action on the control target is being performed, if a movement operation input is provided, the processor 21 controls the movement of the player character PC and also controls the movement of the control target. For example, if the control target is a sole operable object 31, the processor 21 controls the movement of the player character PC and also controls the movement of the operable object 31. If the control target is an operable object 31 included in an assembly object, the processor 21 controls the movement of the player character PC and also controls the movement of the assembly object. In the state where the object operation action on the control target is being performed, for example, if a direction operation input is provided to the analog stick 6L of the controller 4, the processor 21 controls the direction of the player character PC and also controls the movement of the control target. For example, based on key operations on the buttons 5L, the control target is moved or rotated independently of the player character PC.

In the state where the object operation action on the control target is being performed, if the control target and another operable object satisfy a predetermined connection condition, in accordance with a connection instruction, the processor 21 connects the control target to the other operable object. Specifically, in accordance with the connection instruction, the control target and the other operable object come close to each other by pulling each other, and after a predetermined time (e.g., 0.5 seconds), the control target and the other operable object are connected together. Consequently, an assembly object is generated. If the control target is connected to the other operable object, the object operation action on the control target ends.

If a combining instruction is given, in step S102, the processor 21 causes the player character PC to start an action for combining a weapon object with which the player character PC is equipped and an object placed in the virtual space. In accordance with this action, a combined weapon object is generated.

In step S102, based on the operation data, the processor 21 causes the player character PC to start operating the control yoke object 31f. Specifically, in a case where the control yoke object 31f included in an assembly object and the player character PC satisfy a predetermined positional relationship, and if a predetermined start operation is performed, the processor 21 causes the player character PC to start operating the control yoke object 31f. Consequently, the player character PC is placed near the control yoke object 31f and enters the state where the player character PC is operating the control yoke object 31f. When the player character PC is operating the control yoke object 31f, and if a predetermined end operation is performed, the processor 21 causes the player character PC to end the operation on the control yoke object 31f. Consequently, the player character PC moves away from the control yoke object 31f and enters the state where the player character PC is not operating the control yoke object 31f.

After step S102, the processor 21 performs an other object control process (step S103). Here, the processor 21 controls the objects other than the player character PC. For example, in accordance with a predetermined algorithm, the processor 21 moves the enemy character EC by an amount of movement corresponding to a single frame or causes the enemy character EC to start an attack action on the player character PC. In accordance with a predetermined algorithm, the processor 21 also causes the enemy character EC to operate an action object. For example, the processor 21 causes the enemy character EC to perform the action of operating an assembly object or causes the enemy character EC to perform the action of picking up a combined weapon object placed on the ground in the virtual space. The processor 21 also controls a non-player character other than the enemy character EC.

In step S103, the processor 21 controls the behavior of an action object placed in the virtual space (a sole action object or an action object included in an assembly object). For example, if a sole wheel object 31b is in the operating state, the processor 21 makes physical calculations based on the magnitude of the propulsive force of the wheel object 31b, the direction of the propulsive force, a force applied to the wheel object 31b, and a collision with another object, and based on the calculation results, moves the wheel object 31b in the virtual space. The processor 21 also controls the behavior of an assembly object. For example, if the four wheel objects 31b included in the four-wheel vehicle object 41 are in the operating state, the processor 21 makes physical calculations based on the magnitudes of the propulsive forces of the wheel objects 31b, the directions of the propulsive forces, forces applied to the objects included in the four-wheel vehicle object 41, a collision between the four-wheel vehicle object 41 and another object, and the like, calculates the movement (the moving direction and the moving velocity) of the four-wheel vehicle object 41, and updates the position of the four-wheel vehicle object 41. In a case where the control yoke object 31f is connected to the four-wheel vehicle object 41, and if the player character PC is operating the control yoke object 31f, the processor 21 changes the moving direction of the four-wheel vehicle object 41 in accordance with a direction operation input provided by the player. For example, if the fan object 31a included in the airplane object 40 is in the operating state, the processor 21 makes physical calculations based on the magnitude of the propulsive force of the fan object 31a, the direction of the propulsive force, forces applied to the objects included in the airplane object 40, a collision between the airplane object 40 and another object (e.g., the influence of a wind), and the like, calculates the movement of the airplane object 40, and updates the position of the airplane object 40. In a case where the control yoke object 31f is connected to the airplane object 40, and if the player character PC is operating the control yoke object 31f, the processor 21 changes the moving direction of the airplane object 40 in accordance with a direction operation input provided by the player.

Next, the processor 21 performs an object state switching process (step S104). The process of step S104 is the process of switching the states of action objects based on the action of the player character PC or a non-player character (NPC). Specifically, in the object state switching process, the processor 21 sets an action object (a sole action object or an action object included in an assembly object) placed in the virtual space to the operating state or the non-operating state or sets the action object to the possessed state or the non-possessed state. The details of the object state switching process in step S104 will be described below.

Subsequently, the processor 21 performs an energy consumption/recovery process (step S105). In the energy consumption/recovery process, the processor 21 decreases the amount of energy possessed by the player character PC when an action object is in the operating state and the possessed state, or recovers the amount of possessed energy when an action object is in the non-operating state. The details of the energy consumption/recovery process in step S105 will be described below.

Next, the processor 21 performs a drawing process (step S106). Here, an image of the virtual space viewed from the virtual camera placed in the virtual space is generated. Consequently, a game image relating to the processes of steps S101 to S105 is generated. The generated game image is output to the display 12 or another display device. The drawing process in step S106 is repeatedly executed at predetermined frame time intervals, whereby the state where the player character PC moves in the virtual space and the state where the player character PC performs various actions are displayed. The state where a sole action object or an assembly object moves and the state where the amount of energy possessed by the player character PC decreases are also displayed.

Next, the processor 21 determines whether or not to end the game (step S107). For example, if the player gives an instruction to end the game, the processor 21 determines that the game is to be ended. Then, the processor 21 ends the game processing shown in FIG. 21. If, on the other hand, the determination is NO in step S107, the processor 21 executes the process of step S101 again.

### (Object State Switching Process)

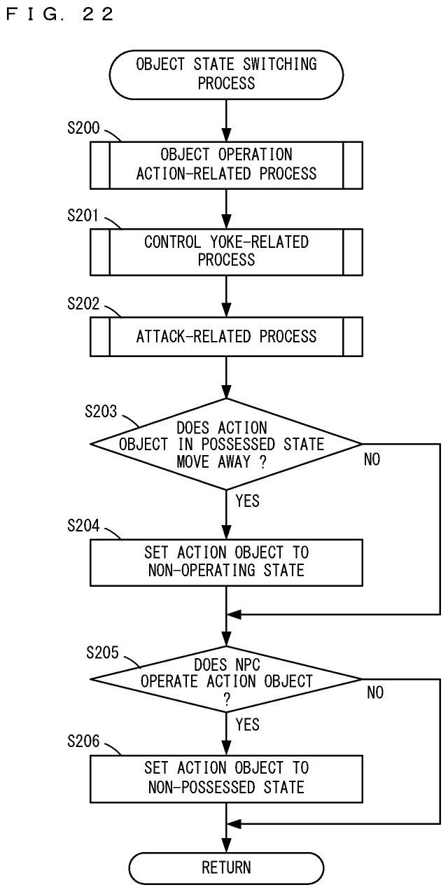

Next, the details of the object state switching process in step S104 are described. FIG. 22 is a flow chart showing an example of the object state switching process in step S104.

As shown in FIG. 22, first, the processor 21 performs an object operation action-related process (step S200). The object operation action-related process is a process related to the object operation action performed in the player character control process in step S102. In the object operation action-related process, based on the object operation action, the processor 21 sets the possession information regarding an action object or sets the operating information regarding an action object. The details of the object operation action-related process will be described below.

Next, the processor 21 performs a control yoke-related process (step S201). The control yoke-related process is a process related to the operation on the control yoke object 31f performed in the player character control process in step S102. In the control yoke-related process, in accordance with the start of the operation on the control yoke object 31f, the processor 21 sets the operating information regarding an action object or sets the possession information regarding an action object. The details of the control yoke-related process will be described below.

Subsequently, the processor 21 performs an attack-related process (step S202). The attack-related process is a process related to the attack action performed in the player character control process in step S102. In the attack-related process, if the attack action of the player character PC hits an action object, the processor 21 changes the action object to the possessed state or changes the operating information regarding the action object. The details of the attack-related process will be described below.

Next, the processor 21 determines whether or not an action object in the possessed state moves away from the player character PC (step S203). Specifically, if the distance between the player character PC and a sole action object in the operating state and the possessed state exceeds a predetermined threshold, the determination of the processor 21 is YES in step S203. If the distance between the player character PC and an assembly object in the operating state and the possessed state exceeds the predetermined threshold, the determination of the processor 21 is YES in step S203. If the distances between the player character PC and all the objects (action objects and non-action objects) included in an assembly object exceed the predetermined threshold, the determination may be YES in step S203. If the distances between the player character PC and all the action objects included in an assembly object exceed the predetermined threshold, the determination may be YES in step S203.

If the determination is YES in step S203, the processor 21 sets the action object to the non-operating state (step S204). For example, if the distance between the player character PC and an assembly object exceeds the predetermined threshold, the processor 21 sets all the action objects included in the assembly object to the non-operating state. If the distance between the player character PC and a sole action object exceeds the predetermined threshold, the processor 21 sets the action object to the non-operating state. At the timing when a predetermined time elapses after the determination is YES in step S203, the action object may be set to the non-operating state.

If the process of step S204 is executed, or if the determination is NO in step S203, the processor 21 determines whether or not a non-player character operates an action object (step S205). For example, if the enemy character EC operates an assembly object placed in the virtual space on the assembly object in step S103, the determination of the processor 21 is YES in step S205. For example, if the enemy character EC picks up a combined weapon object including an action object placed on the ground in the virtual space, the determination of the processor 21 is YES in step S205. If the attack action of the enemy character EC hits an assembly object placed in the virtual space, the determination of the processor 21 may be YES in step S205. For example, if the attack action of the enemy character EC hits a sole action object placed in the virtual space, the determination of the processor 21 may be YES in step S205.

If the determination is YES in step S205, the processor 21 sets the action object operated by the non-player character to the non-possessed state (step S206). For example, if the enemy character EC operates an assembly object placed in the virtual space on the assembly object, the processor 21 sets all the action objects included in the assembly object to the non-possessed state. At this time, the processor 21 may set all the action objects included in the assembly object to the non-possessed state and also set all the action objects included in the assembly object to the operating state. If the enemy character EC picks up a combined weapon object placed on the ground in the virtual space, the processor 21 sets an action object included in the combined weapon object to the non-possessed state. If the attack action of the enemy character EC hits an assembly object placed in the virtual space, the processor 21 may set all the action objects included in the assembly object to the non-possessed state and also set all the action objects included in the assembly object to the operating state. If the attack action of the enemy character EC hits a sole action object placed in the virtual space, the processor 21 may set the action object to the non-possessed state and also set the action object to the operating state.

A non-action object may also have possession information. In step S206, not only the action object but also a non-action object may be set to the non-possessed state. For example, if the enemy character EC operates an assembly object, the processor 21 may set all the objects (action objects and non-action objects) included in the assembly object to the non-possessed state.

If the process of step S206 is performed, or if the determination is NO in step S205, the processor 21 ends the process shown in FIG. 22.

### (Object Operation Action-Related Process)

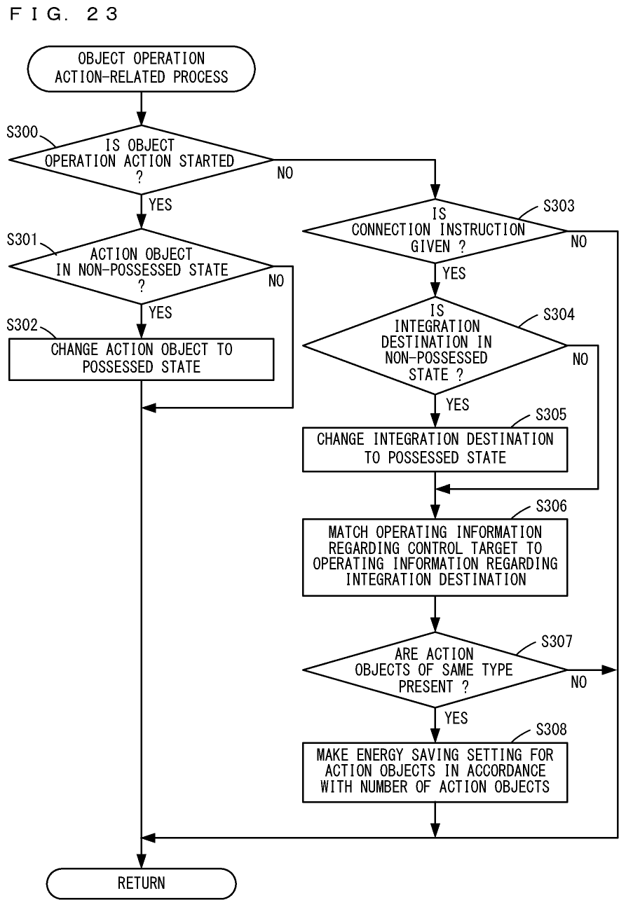

Next, the details of the object operation action-related process in step S200 in FIG. 22 are described. FIG. 23 is a flow chart showing an example of the object operation action-related process in step S200.

As shown in FIG. 23, the processor 21 determines whether or not the object operation action is started in the above step S102 (step S300). Here, when an operable object 31 is selected by a selection operation of the player, it is determined whether or not the object operation action on the selected object is started by giving a predetermined operation input (e.g., the pressing of the A-button).

If the object operation action is started (step S300: YES), the processor 21 determines whether or not the control target of the object operation action is an action object in the non-possessed state (step S301). For example, if the control target is a sole action object in the non-possessed state, the determination of the processor 21 is YES in step S301. If the control target is an operable object (an action object or a non-action object) included in an assembly object, and the assembly object is in the non-possessed state, the determination of the processor 21 is YES in step S301.

If the determination is YES in step S301, the processor 21 changes the action object as the control target of the object operation action to the possessed state (step S302). Here, if the control target is a sole action object, the sole action object is changed to the possessed state. If the control target is an action object or a non-action object included in an assembly object, all the action objects included in the assembly object are changed to the possessed state. Specifically, a value indicating the possessed state is set for the possession information regarding the entirety of the assembly object, and the possession information regarding the entirety of the assembly object is copied to the possession information regarding all the action objects included in the assembly object. The assembly object may not have the possession information regarding the entirety of the assembly object, and a value indicating the possessed state may be set for the possession information regarding the action objects included in the assembly object. If a plurality of action objects of the same type are included in an assembly object that is not in the possessed state, an energy saving setting is made at the time when the assembly object is placed in the virtual space. However, the energy saving setting may not be made at the time of the placement, and the energy saving setting may be made at the time of step S302. As described above, when the object operation action is started on a sole action object or an assembly object, the sole action object or an action object included in the assembly object is changed to the possessed state. A non-action object may also have possession information. In step S302, not only the action object but also a non-action object may be set to the possessed state.

If the process of step S302 is executed, or if the determination is NO in step S301, the processor 21 ends the process shown in FIG. 23.

If, on the other hand, it is not determined that the object operation action is started (step S300: NO), the processor 21 determines whether or not a connection instruction is given by the player (step S303). Here, while the player character PC is operating the control target based on the object operation action, it is determined whether or not a connection instruction to connect the control target to another operable object 31 is given.

If a connection instruction is given (step S303: YES), the processor 21 determines whether or not an object as the integration destination is in the non-possessed state (step S304). Here “the object as the integration destination” is an object to which the control target of the object operation action is to be connected, and is a sole action object or an assembly object to which the control target is to be connected. For example, if the control target is to be connected to a sole action object placed in the virtual space, it is determined whether or not the sole action object is in the non-possessed state. If the control target is to be connected to an assembly object placed in the virtual space, it is determined whether or not an action object included in the assembly object is in the non-possessed state.

If it is determined that the object as the integration destination is in the non-possessed state (step S304: YES), the processor 21 changes the object as the integration destination to the possessed state (step S305). For example, if the control target is to be connected to a sole action object placed in the virtual space, the sole action object is changed to the possessed state. If the control target is to be connected to an assembly object placed in the virtual space, all the action objects included in the assembly object are changed to the possessed state. Specifically, a value indicating the possessed state is set for the possession information regarding the entirety of the assembly object, and the possession information regarding the entirety of the assembly object is copied to the possession information regarding all the action objects included in the assembly object. A non-action object may also have possession information. In step S305, not only the action object but also a non-action object may be set to the possessed state.

If the process of step S305 is executed, or if the determination is NO in step S304, the processor 21 matches the operating information regarding the action object as the control target to the operating information regarding the object as the integration destination (step S306). Consequently, if the control target is to be connected to a sole action object in the operating state, the control target is set to the operating state. If the control target is to be connected to a sole action object in the non-operating state, the control target is set to the non-operating state. In a case where the control target is an assembly object, and if the assembly object is in the operating state, the control target is set to the operating state. In a case where the control target is an assembly object, and if the assembly object is in the non-operating state, the control target is set to the non-operating state.

If the control target is to be connected to the action object, the operating information regarding the object as the integration destination (the connection destination) may be matched to the operating information regarding the control target.

After step S306, the processor 21 determines whether or not a plurality of action objects of the same type are present in the objects as the control target and the integration destination (step S307). Here, it is determined whether or not a plurality of action objects of the same type are present in a plurality of action objects including the control target and a sole action object or an action object included in an assembly object as the integration destination. For example, a case is assumed where, as shown in FIG. 18, a wheel object 31b is the control target, and a connection instruction is given when the control target and the three-wheel vehicle object 52 satisfy a connection condition. In this case, three wheel objects 31b are present in the three-wheel vehicle object 52 as the integration destination, and the control target is a wheel object 31b. Thus, four wheel objects 31b are present in the objects as the control target and the integration destination. Thus, in this case, the determination is YES in step S307.

If it is determined that a plurality of action objects of the same type are present in the objects as the control target and the integration destination (step S307: YES), the processor 21 makes an energy saving setting for the action objects of the same type in accordance with the number of the action objects (step S308). Here, the processor 21 sets the consumption amounts of the action objects so that the total consumption amount of the plurality of action objects of the same type is smaller than the normal total consumption amount when the energy saving setting is not made. For example, the consumption amounts of the action objects may be set to be smaller than the normal consumption amounts. The consumption amount of a first action object may be set to be the same as normal, and the consumption amounts of second and subsequent action objects may be set to be smaller than normal. For example, if four wheel objects 31b are present in the objects as the control target and the integration destination, the total consumption amount of the four wheel objects 31b is “the normal consumption amount of a wheel object 31b×4” if the energy saving setting is not made. However, the energy saving setting is made for the action objects of the same type in step S308, whereby the total consumption amount of the four wheel objects 31b is smaller than “the normal consumption amount of a wheel object 31b×4”.

Not only in a case where a plurality of action objects of the same type are present in an assembly object, but also in accordance with the type of the action object and the location in the virtual space, the energy saving setting may be made. For example, when the fan object 31b is moving in the air, the fan object 31b may be set to a normal consumption amount, and when the fan object 31b is moving on the ground or a water surface, the fan object 31b may be set to a consumption amount smaller than normal.

If the process of step S308 is performed, or if the determination is NO in step S307, or if the determination is NO in step S303, the processor 21 ends the process shown in FIG. 23.

### (Control Yoke-Related Process)

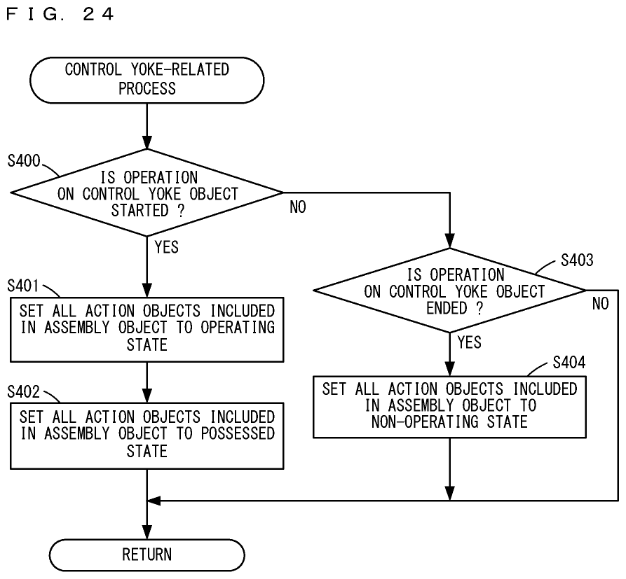

Next, the details of the control yoke-related process in step S201 in FIG. 22 are described. FIG. 24 is a flow chart showing an example of the control yoke-related process in step S201.

As shown in FIG. 24, the processor 21 determines whether or not the player character PC starts operating the control yoke object 31f included in an assembly object in the above step S102 (step S400).

If the player character PC starts operating the control yoke object 31f included in the assembly object (step S400: YES), the processor 21 sets all the action objects included in the assembly object to the operating state (step S401).

Next, the processor 21 sets all the action objects included in the assembly object to the possessed state (step S402). Specifically, a value indicating the possessed state is set for the possession information regarding the entirety of the assembly object, and the possession information regarding the entirety of the assembly object is copied to the possession information regarding the action objects included in the assembly object. If a plurality of action objects of the same type are included in an assembly object that is not in the possessed state, an energy saving setting is made at the time when the assembly object is placed in the virtual space. However, the energy saving setting may not be made at the time of the placement, and the energy saving setting may be made at the time of step S402. A non-action object may also have possession information. In step S402, not only the action objects but also a non-action object may be set to the possessed state.

If, on the other hand, the determination is NO in step S400, the processor 21 determines whether or not the player character PC ends the operation on the control yoke object 31f included in the assembly object in the above step S102 (step S403).

If it is determined that the player character PC ends the operation on the control yoke object 31f included in the assembly object (step S403: YES), the processor 21 sets all the action objects included in the assembly object to the non-operating state (step S404).

If the process of step S404 is performed, or if the determination is NO in step S403, or if the process of step S402 is performed, the processor 21 ends the process shown in FIG. 24.

### (Attack-Related Process)

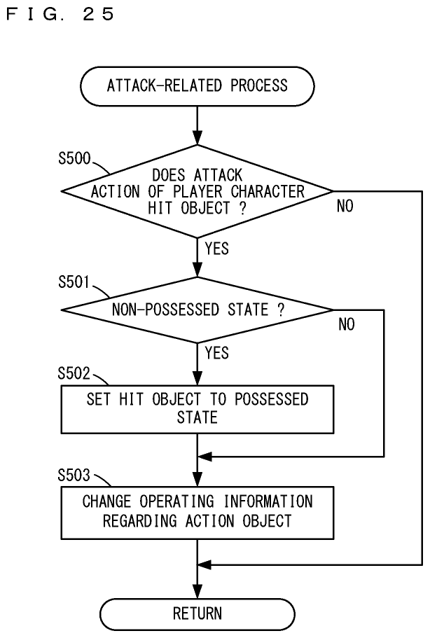

Next, the details of the attack-related process in step S202 in FIG. 22 are described. FIG. 25 is a flow chart showing an example of the attack-related process in step S202.

As shown in FIG. 25, the processor 21 determines whether or not the attack action of the player character PC performed in the above step S102 hits an object (step S500). Specifically, the processor 21 determines whether or not the attack action of the player character PC that is being executed hits a sole action object or an assembly object (an action object or a non-action object included in the assembly object) placed in the virtual space.

If the attack action of the player character PC hits an object (step S500: YES), the processor 21 determines whether or not the object hit by the attack action is in the non-possessed state (step S501). For example, if the attack action of the player character PC hits a sole action object, the processor 21 determines whether or not the action object is in the non-possessed state. If the attack action of the player character PC hits an assembly object, the processor 21 determines whether or not an action object included in the assembly object is in the non-possessed state.

If it is determined that the object hit by the attack action is in the non-possessed state (step S501: YES), the processor 21 sets the object hit by the attack action to the possessed state (step S502). For example, if the attack action of the player character PC hits a sole action object, the processor 21 sets the action object to the possessed state. If the attack action of the player character PC hits an assembly object, the processor 21 sets all the action objects included in the assembly object to the possessed state. Specifically, a value indicating the possessed state is set for the possession information regarding the entirety of the assembly object, and the possession information regarding the entirety of the assembly object is copied to the possession information regarding the action objects included in the assembly object. A non-action object may also have possession information. In step S502, not only the action object but also a non-action object may be set to the possessed state.

If the process of step S502 is performed, or if the determination is NO in step S501, the processor 21 changes the operating information regarding the object hit by the attack action of the player character PC (step S503). Here, the processor 21 switches the operating state and the non-operating state of an action object. For example, if the attack action of the player character PC hits a sole action object, the processor 21 switches the action object from the non-operating state to the operating state or from the operating state to the non-operating state. If the attack action of the player character PC hits the assembly object, the processor 21 switches all the action objects included in the assembly object from the non-operating state to the operating state or from the operating state to the non-operating state.

If the process of step S503 is performed, or if the determination is NO in step S500, the processor 21 ends the process shown in FIG. 25.

### (Energy Consumption/Recovery Process)

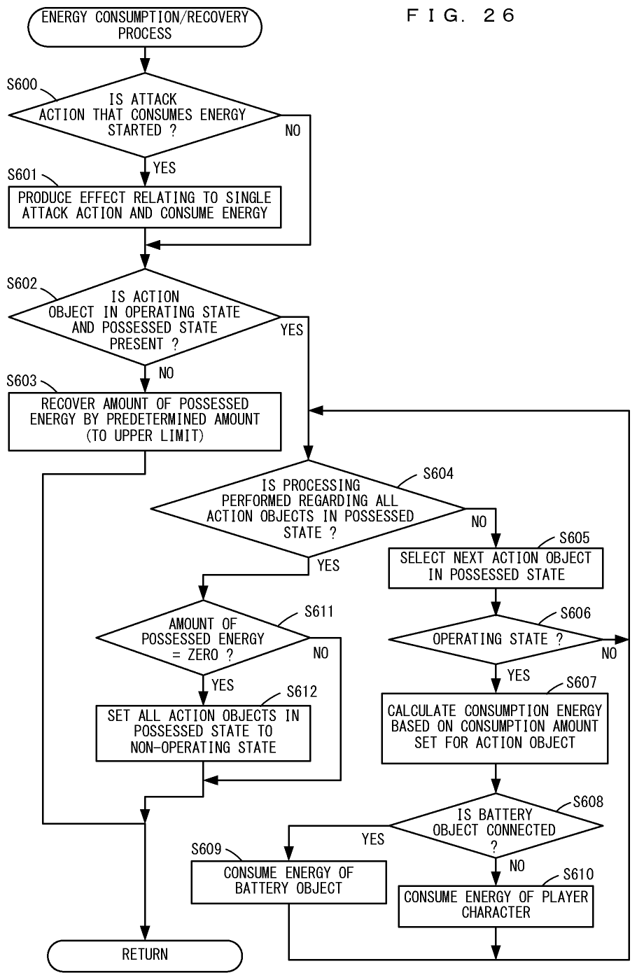

Next, the details of the energy consumption/recovery process in step S105 in FIG. 21 are described. FIG. 26 is a flow chart showing an example of the energy consumption/recovery process in step S105.

As shown in FIG. 26, the processor 21 determines whether or not the player character PC starts an attack action that consumes energy in the above step S102 (step S600). Specifically, the processor 21 determines whether or not the player character PC starts the attack action using a combined weapon object including an action object in the above step S102.

If it is determined that the player character PC starts an attack action that consumes energy (step S600: YES), the processor 21 produces an effect relating to a single attack action and consumes energy (step S601). Specifically, the processor 21 sets the action object included in the combined weapon object to the operating state and produces an effect relating to the action object. If a predetermined time (e.g., 0.5 seconds) elapses after the action object is set to the operating state in step S601, the action object is set to the non-operating state. The processor 21 also subtracts a consumption amount relating to the action object included in the combined weapon object from the amount of energy possessed by the player character PC. If a display flag in the energy display 33 is OFF, the processor 21 sets the display flag in the energy display 33 to ON. Consequently, the energy display 33 is displayed. For example, if the player character PC starts an attack action using the combined weapon object 37 including the flamethrower object 31c, as shown in FIG. 17, a flame 38 is thrown from the flamethrower object 31c. A consumption amount relating to the throwing of the flame 38 is subtracted from the amount of possessed energy. If the amount of possessed energy is smaller than the consumption amount relating to the action object included in the combined weapon object, the action object is not set to the operating state, and the consumption amount is not subtracted from the amount of possessed energy, either.

The timing of the production of the effect of the attack action using the combined weapon object and the decrease in the possessed energy is not limited to the timing when the attack action is started, and may be any timing during the execution of the attack action. At the timing when the attack action ends, the effect of the attack action may be produced, and the possessed energy may decrease.

If the process of step S601 is executed, or if the determination is NO in step S600, the processor 21 determines whether or not an action object in the operating state and the possessed state is present in the virtual space (step S602). Until a predetermined time elapses after an action object in the operating state and the possessed state ceases to be present in the virtual space, the determination may be YES in step S602. After the predetermined time elapses, the determination may be NO in step S602.

If it is determined that an action object in the operating state and the possessed state is not present in the virtual space (step S602: NO), the processor 21 recovers the amount of energy possessed by the player character PC by a predetermined amount (step S603). If the display flag in the energy display 33 is OFF, the processor 21 sets the display flag in the energy display 33 to ON. The amount of possessed energy is recovered up to the upper limit value. If step S603 is executed, the processor 21 ends the process shown in FIG. 26.

If, on the other hand, it is determined that an action object in the operating state and the possessed state is present (step S602: YES), the processor 21 determines whether or not the processing is performed regarding all the action objects in the possessed state in the current process in FIG. 26 (step S604). Here, it is determined whether or not the processes of steps S605 to S610 are performed regarding all the action objects in the possessed state.

If the determination is NO in step S604, the processor 21 selects as a processing target an action object in the possessed state that has not yet been subjected to the processing (step S605), and determines whether or not the action object as the processing target is in the operating state (step S606).

If the action object as the processing target is in the operating state (step S606: YES), the processor 21 calculates consumption energy based on the consumption amount set for the action object as the processing target (step S607). For example, if the above energy saving setting is made for the action object as the processing target, the processor 21 calculates the consumption amount smaller than normal set in step S308 as consumption energy for a single frame. If the above energy saving setting is not made for the action object as the processing target, the processor 21 calculates the consumption amount set in advance for the action object as the processing target as consumption energy for a single frame. In a special case during the game, such as a case where an energy saving ability is exerted in the player character PC or a case where the game is in the state where energy is not consumed at a certain time or at a predetermined location, an energy consumption amount is calculated in accordance with this state.

Next, the processor 21 determines whether or not the battery object 31h is connected to an assembly object including the action object as the processing target (step S608).

If the determination is YES in step S608, the processor 21 consumes the energy of the battery object 31h (step S609). Specifically, the processor 21 subtracts the consumption energy of the action object as the processing target calculated in step S607 from the remaining amount of energy of the battery object 31h. If the remaining amount of energy of the battery object 31h reaches zero, the battery object 31h disappears. If the display flags in the energy display 33 and the second energy display 34 are OFF, the processor 21 sets the display flags in the energy display 33 and the second energy display 34 to ON. Even if the remaining amount of energy of the battery object 31h reaches zero, the battery object 31h may not disappear. In this case, even if the battery object 31h is connected to the assembly object, but if the remaining amount of energy of the battery object 31h is zero, the determination is NO in the above step S608.

If the determination is NO in step S608, the processor 21 consumes the energy possessed by the player character PC (step S610). Specifically, the processor 21 subtracts the consumption energy of the action object as the processing target calculated in step S607 from the amount of energy possessed by the player character PC. If the display flag in the energy display 33 is OFF, the processor 21 sets the display flag in the energy display 33 to ON.

If the process of step S610 is performed, or if the process of step S609 is performed, or if the determination is NO in step S606, the processor 21 executes the process of step S604 again.

If, on the other hand, the determination is YES in step S604, the processor 21 determines whether or not the amount of energy possessed by the player character PC reaches zero (step S611).

If the amount of energy possessed by the player character PC reaches zero (step S611: YES), the processor 21 sets all the action objects in the possessed state present in the virtual space to the non-operating state (step S612). Until a predetermined time elapses after the determination is YES in step S611, the action objects may not be set to the non-operating state. If the predetermined time elapses, the action objects may be set to the non-operating state. If all the action objects in the possessed state are set to the non-operating state in step S612, the amount of energy possessed by the player character PC may be recovered in the above step S603 in subsequent processing loops, but the action objects may be controlled not to change to the operating state until the amount of possessed energy recovers to a predetermined value (e.g., the upper limit value). That is, if the process of step S612 is performed, until the amount of possessed energy is recovered to the predetermined value, the action objects may not be set to the operating state even in a case where the control yoke object is operated (YES in step S400) or even in a case where the attack action of the player character PC hits an action object or an assembly object (YES in step S500). If the amount of energy possessed by the player character PC reaches zero, an assembly object in the possessed state to which the battery object 31h is not connected may be set to the non-operating state, but an assembly object in the possessed state to which the battery object 31h is connected may be maintained in the operating state until the remaining amount of energy of the battery object 31h reaches zero. Conversely, if the amount of energy possessed by the player character PC reaches zero, all the action objects in the possessed state may be set to the non-operating state, regardless of the presence or absence of the remaining amount of energy of the battery object 31h.

If the process of step S612 is performed, or if the determination is NO in step S611, or if the process of step S603 is performed, the processor 21 ends the process shown in FIG. 26.

As described above, in the game according to the above exemplary embodiment, the player character PC is caused to perform any of a plurality of behaviors including a plurality of actions and a movement in a virtual space (S102). A plurality of action objects (e.g., the operable objects 31a to 31c) are placed in the virtual space. For each of the action objects, operating information indicating in which state of an operating state and a non-operating state the action object is, possession information indicating in which state of a possessed state and a non-possessed state the action object is, a type, and a consumption amount for a first parameter (the amount of possessed energy) associated with the player character PC are set. Based on the action of the player character PC (e.g., an attack action or the action of operating a control yoke object), the operating state and the non-operating state of an action object are switched (S401, S503). Based on the action of the player character PC (e.g., an attack action or the action of operating the control yoke object), an action object in the non-possessed state is changed to the possessed state (S402, S502). Action objects in the operating state continuously perform behaviors set according to types in the virtual space (S103). Based on the consumption amount set for each of the action objects in the operating state and the possessed state, the first parameter (the amount of possessed energy) is continuously decreased (S610). If the first parameter decreases to a predetermined reference, an action object in the operating state and the possessed state is changed to the non-operating state (S612).

Consequently, based on the action of the player character PC, it is possible to switch the operating state and the non-operating state of the action objects. If a plurality of action objects are in the operating state, it is possible to cause the plurality of action objects to perform behaviors relating to the types of the plurality of action objects. Based on the action of the player character PC, it is possible to change an action object in the non-possessed state to the possessed state and manage the operating of an action object in the possessed state based on the first parameter associated with the player character PC, while it is possible to cause an action object in the non-possessed state to operate, regardless of the first parameter.

In the above exemplary embodiment, if the attack action of the player character PC hits an action object, the operating state and the non-operating state of the action object are switched, and the action object is set to the possessed state. Consequently, based on the attack action of the player character PC, it is possible to set an action object to the operating state and also to the possessed state.

In the above exemplary embodiment, if an object operation action is performed on an action object, the action object is changed to the possessed state. If a control target is integrated with another action object or an assembly object based on the object operation action, all the action objects included in the integration destination are set to the possessed state. Consequently, it is possible to set all the action objects in an assembly object to the possessed state.

In the above exemplary embodiment, if a control target is integrated with another action object or an assembly object, the setting of the control target regarding in which state of the operating state and the non-operating state the control target is is set to be the same as that of an action object as the integration destination. Consequently, it is possible to match the operating information regarding the control target to the operating information regarding the integration destination. For example, even in a case where a control target is integrated with an assembly object that is moving, it is possible to prevent the assembly object that is moving from stopping due to the integration.

In the above exemplary embodiment, if a plurality of action objects of the same type are included in an assembly object, the consumption amounts of the plurality of action objects of the same type are reduced. Consequently, even in a case where a plurality of action objects of the same type are included in an assembly object, it is possible to prevent the amount of energy possessed by the player character PC from rapidly decreasing.

In the above exemplary embodiment, if the battery object 31h is included in an assembly object, the energy of the battery object 31h is preferentially consumed. If the remaining amount of energy of the battery object 31h reaches zero, the amount of energy possessed by the player character PC is decreased. Consequently, until the remaining amount of energy of the battery object 31h reaches zero. it is possible to reduce a decrease in the amount of energy possessed by the player character PC.

In the above exemplary embodiment, if the distance between the player character PC and an assembly object exceeds a predetermined threshold, an action object included in the assembly object is set to the non-operating state. Consequently, if an assembly object in the operating state and the possessed state moves away from the player character PC, it is possible to stop the assembly object. In a case where the assembly object continues to move even if the assembly object moves away from the player character PC, the assembly object may move further away from the player character PC. Thus, it may be difficult to stop the assembly object, and the amount of possessed energy may be wastefully consumed. In the above exemplary embodiment, however, if an assembly object moves away from the player character PC, the assembly object stops. Thus, it is possible to prevent the amount of possessed energy from being wastefully consumed.

### (Variations)

While the exemplary embodiment has been described above, the exemplary embodiment is merely an example and may be modified as follows, for example.

For example, the processes shown in the above flow charts are merely illustrative, and the order and the contents of the processes, and the like may be appropriately changed.

For example, in the above exemplary embodiment, the amount of possessed energy is set for the player character PC, and if an action object is in the operating state and the possessed state, the amount of energy possessed by the player character PC is decreased based on the consumption amount set for the action object. If the amount of possessed energy decreases to a predetermined reference, the action object is set to the non-operating state. In another exemplary embodiment, if an action object is in the operating state and the possessed state, conversely, a certain parameter (e.g., the degree of fatigue) related to the player character PC may be increased. In this case, if the certain parameter related to the player character PC increases to a predetermined reference, the action object is set to the non-operating state. Such an increase in the numerical value of a certain parameter can be grasped as a decrease in another parameter from a different viewpoint. That is, if an action object is in the operating state and the possessed state, a first parameter related to the player character may be decreased, and if the first parameter decreases to a predetermined reference, the action object may be set to the non-operating state. Here, “the first parameter decreases” includes a decrease in a certain value and an increase in a certain value.

In the above exemplary embodiment, at the timing when an action object becomes a control target of the object operation action, the control target is set to the possessed state. Then, if the control target is connected to and integrated with another action object or an assembly object, the other action object or an action object included in the assembly object is set to the possessed state at the timing of the integration. In another exemplary embodiment, the timing when an action object or an action object included in an assembly object is set to the possessed state based on the object operation action may be any timing. For example, at the timing when the control target is connected to and integrated with another action object or an assembly object, all the action objects including the control target may be set to the possessed state. That is, all the action objects in the assembly object including the control target may be set to the possessed state at the timing of the integration.

In the above exemplary embodiment, an action object includes the operating information indicating the operating state or the non-operating state and the possession information indicating the possessed state or the non-possessed state. If the action object is in the operating state and the possessed state, the amount of energy possessed by the player character PC is decreased. In another exemplary embodiment, an action object may include first information indicating either of a first state (e.g., the operating state) and a second state (e.g., the non-operating state) other than the first state, and second information indicating either of a third state (the possessed state) and a fourth state (the non-possessed state) other than the third state. Then, if the action object is in the first state, the action object may be caused to continuously perform a behavior relating to the type of the object. If the action object is in the first state and the third state, a first parameter (e.g., the amount of possessed energy) associated with the player character PC may be continuously decreased.

In the above exemplary embodiment, if an action object is in the operating state, the action object is caused to continuously perform a behavior relating to the type of the action object in the virtual space. Here, for example, “the action object is caused to perform a behavior relating to the type of the action object” may include the generation of a propulsive force by rotation, the generation of a wind, the generation of a propulsive force in a direction opposite to the generation direction of a wind, the generation of a flame, the generation of a beam, and the like. “Continuously performing a behavior” may include not only a case where the behavior is always performed for a predetermined period, but also a case where the behavior is intermittently performed. That is, “continuously performing a behavior” may include the continuation of the state where the behavior is being performed, and the repetition of the state where the behavior is being performed and the state where the behavior is not being performed.

In the above exemplary embodiment, if an action object is in the operating state and the possessed state, a first parameter (specifically, the amount of possessed energy) related to the player character PC is continuously decreased. Here, “the first parameter is continuously decreased” may include not only a case where the first parameter always continues to be decreased for a predetermined period, but also a case where the first parameter is intermittently decreased.

In the above exemplary embodiment, if the battery object 31h is included in an assembly object, the energy of the battery object 31h is consumed first. The amount of energy possessed by the player character PC is configured not to decrease until the battery remaining amount of the battery object 31h reaches zero. In another exemplary embodiment, until a second parameter decreases a predetermined reference, a first parameter related to the player character PC may also be decreased, and the amount of decrease in the first parameter may be reduced. That is, “the amount of decrease in the first parameter is reduced” includes both a case where the first parameter does not decrease at all, and a case where the amount of decrease in the first parameter is smaller than normal.

The configuration of the hardware that performs the above game processing is merely an example, and the above game processing may be performed by any other hardware. For example, the above game processing may be executed by any information processing system such as a personal computer, a tablet terminal, a smartphone, or a server on the Internet. The above game processing may also be executed in a dispersed manner by a plurality of apparatuses.

The configurations of the above exemplary embodiment and its variations can be optionally combined together unless they contradict each other. Further, the above description is merely an example of the exemplary embodiment, and may be improved and modified in various manners other than the above.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. A non-transitory computer-readable storage medium having stored therein instructions that, when executed, cause one or more processors of an information processing apparatus to execute game processing comprising:
based on operation data, controlling a player character in accordance with any of behaviors at least including a plurality of actions and a movement in a virtual space;
placing a plurality of objects in a first classification in the virtual space, each object having at least:
information indicating in which state of a first state and a second state other than the first state the object is;
information indicating in which state of a third state and a fourth state other than the third state the object is;
a type; and
a consumption amount for a first parameter associated with a player;
based on at least any of the actions, switching the first state and the second state of at least any of the objects in the first classification;
based on at least any of the actions, changing at least any of the objects in the first classification in the fourth state to the third state;
causing each of the objects in the first classification in the first state to continuously perform a behavior set with respect to each of the types in the virtual space;
based on the consumption amount of each of the objects in the first classification in the first state and the third state, continuously decreasing the first parameter; and
if the first parameter decreases to a predetermined reference, changing the object in the first classification in the first state and the third state from the first state to the second state.

2. The non-transitory computer-readable storage medium according to claim 1, wherein
the plurality of actions include an attack action, and
the game processing further comprises:
if the attack action hits an object in the first classification, switching the first state and the second state of the object in the first classification, and further, if the object in the first classification is in the fourth state, changing the object in the first classification to the third state.

3. The non-transitory computer-readable storage medium according to claim 1, wherein
the plurality of actions includes an object operation action for, using as a control target an object specified among objects in a second classification that is a classification at least including an object in the first classification, at least controlling a movement of the control target, and
the game processing further comprises
in a case where the player character performs the object operation action on the object in the first classification as the control target, and if the control target is in the fourth state, changing the control target to the third state.

4. The non-transitory computer-readable storage medium according to claim 3, wherein
the game processing further comprises
performing integration control for integrating the control target with another object in the second classification in the object operation action, thereby generating an assembly object, and if an object in the fourth state is included in an integration destination, changing the object in the fourth state to the third state.

5. The non-transitory computer-readable storage medium according to claim 4, wherein
the game processing further comprises
if the control target is an object in the first classification, and the integration destination is another object in the first classification or the assembly object including the other object in the first classification in the integration control in the object operation action, setting the information regarding the control target indicating in which state of the first state and the second state the control target is in to be the same as the information regarding an object in the first classification included in the integration destination.

6. The non-transitory computer-readable storage medium according to claim 5, wherein
the plurality of actions include an attack action, and
the game processing further comprises
if the attack action hits the assembly object, switch the first state and the second state of all objects in the first classification included in the assembly object, and if an object in the fourth state is included in the assembly object, changing the object in the fourth state to the third state.

7. The non-transitory computer-readable storage medium according to claim 5, wherein
the objects in the second classification include a switching object capable of entering either of an operated state where the switching object is operated by the player character and a non-operated state where the switching object is not operated by the player character,
the plurality of actions include a switching object operation action for changing the switching object to the operated state, and
the game processing further comprises
in a case where the switching object is included in the assembly object, and if the switching object enters the operated state, setting all objects in the first classification included in the assembly object to the first state, and if the switching object enters the non-operated state, setting all the objects in the first classification included in the assembly object to the second state.

8. The non-transitory computer-readable storage medium according to claim 4, wherein
the game processing further comprises
if the assembly object including a plurality of objects in the first classification of the same type is generated by the integration control of the object operation action, reducing the consumption amount set for at least any of the plurality of objects in the first classification.

9. The non-transitory computer-readable storage medium according to claim 4, wherein
an object in the second classification includes a parameter object with which a second parameter is associated, and
the game processing further comprises:
in a case where the parameter object is included in the assembly object, and if an object in the first classification included in the assembly object is in the first state and the third state, decreasing the second parameter based on the consumption amount of each of objects in the first classification included in the assembly object; and
reducing an amount of decrease in the first parameter until the second parameter decreases to a predetermined reference.

10. The non-transitory computer-readable storage medium according to claim 1, wherein
the game processing further comprises
changing an object in the first classification of which a distance from the player character exceeds a predetermined reference to the second state.

11. The non-transitory computer-readable storage medium according to claim 4, wherein
the game processing further comprises
if distances between the player character and all objects in the second classification included in the assembly object exceed a predetermined reference, changing an object in the first classification included in the assembly object to the second state.

12. The non-transitory computer-readable storage medium according to claim 1, wherein
the game processing further comprises
in a case where the first parameter is less than a predetermined upper limit value, and if an object in the first classification in the first state and the third state is not present in the virtual space, continuously increasing the first parameter to the upper limit value.

13. The non-transitory computer-readable storage medium according to claim 1, wherein
the plurality of actions include:
a combined weapon generation action for integrating an object in the second classification with a weapon object, thereby generating a combined weapon object; and
a weapon attack action for making an attack using the weapon object or the combined weapon object, and
the game processing further comprises
if the weapon attack action using the combined weapon object including an object in the first classification is performed, decreasing the first parameter by a predetermined amount.

14. The non-transitory computer-readable storage medium according to claim 1, wherein
the game processing further comprises:
controlling a non-player character in the in the virtual space; and
if the non-player character uses an object in the first classification in the third state, setting the object in the first classification to the fourth state.

15. An information processing system comprising:
one or more processors that execute game processing comprising:
based on operation data, controlling a player character in accordance with any of behaviors at least including a plurality of actions and a movement in a virtual space;
placing a plurality of objects in a first classification in the virtual space, each object having at least:
information indicating in which state of a first state and a second state other than the first state the object is;
information indicating in which state of a third state and a fourth state other than the third state the object is;
a type; and
a consumption amount for a first parameter associated with a player:
based on at least any of the actions, switching the first state and the second state of at least any of the objects in the first classification;
based on at least any of the actions, changing at least any of the objects in the first classification in the fourth state to the third state;
causing each of the objects in the first classification in the first state to continuously perform a behavior set with respect to each of the types in the virtual space;
based on the consumption amount of each of the objects in the first classification in the first state and the third state, continuously decreasing the first parameter; and
if the first parameter decreases to a predetermined reference, changing the object in the first classification in the first state and the third state from the first state to the second state.

16. The information processing system according to claim 15, wherein
the plurality of actions include an attack action, and
the game processing further comprises
if the attack action hits an object in the first classification, switching the first state and the second state of the object in the first classification, and further, if the object in the first classification is in the fourth state, changing the object in the first classification to the third state.

17. The information processing system according to claim 15, wherein
the plurality of actions includes an object operation action for, using as a control target an object specified among objects in a second classification that is a classification at least including an object in the first classification, at least controlling a movement of the control target, and
the game processing further comprises
in a case where the player character performs the object operation action on the object in the first classification as the control target, and if the control target is in the fourth state, changing the control target to the third state.

18. The information processing system according to claim 17, wherein
the game processing further comprises
performing integration control for integrating the control target with another object in the second classification in the object operation action, thereby generating an assembly object, and if an object in the fourth state is included in an integration destination, changing the object in the fourth state to the third state.

19. The information processing system according to claim 18, wherein
the game processing further comprises
if the control target is an object in the first classification, and the integration destination is another object in the first classification or the assembly object including the other object in the first classification in the integration control in the object operation action, setting the information regarding the control target indicating in which state of the first state and the second state the control target is in to be the same as the information regarding an object in the first classification included in the integration destination.

20. The information processing system according to claim 19, wherein
the plurality of actions include an attack action, and
the game processing further comprises
if the attack action hits the assembly object, switch the first state and the second state of all objects in the first classification included in the assembly object, and if an object in the fourth state is included in the assembly object, changing the object in the fourth state to the third state.

21. The information processing system according to claim 19, wherein
the objects in the second classification include a switching object capable of entering either of an operated state where the switching object is operated by the player character and a non-operated state where the switching object is not operated by the player character,
the plurality of actions include a switching object operation action for changing the switching object to the operated state, and
the game processing further comprises
in a case where the switching object is included in the assembly object, and if the switching object enters the operated state, setting all objects in the first classification included in the assembly object to the first state, and if the switching object enters the non-operated state, setting all the objects in the first classification included in the assembly object to the second state.

22. The information processing system according to claim 18, wherein
the game processing further comprises
if the assembly object including a plurality of objects in the first classification of the same type is generated by the integration control of the object operation action, reducing the consumption amount set for at least any of the plurality of objects in the first classification.

23. The information processing system according to claim 18, wherein
an object in the second classification includes a parameter object with which a second parameter is associated, and
the game processing further comprises:
in a case where the parameter object is included in the assembly object, and if an object in the first classification included in the assembly object is in the first state and the third state, decreasing the second parameter based on the consumption amount of each of objects in the first classification included in the assembly object; and
reducing an amount of decrease in the first parameter until the second parameter decreases to a predetermined reference.

24. The information processing system according to claim 15, wherein
the game processing further comprises
changing an object in the first classification of which a distance from the player character exceeds a predetermined reference to the second state.

25. The information processing system according to claim 18, wherein
the game processing further comprises
if distances between the player character and all objects in the second classification included in the assembly object exceed a predetermined reference, changing an object in the first classification included in the assembly object to the second state.

26. The information processing system according to claim 15, wherein
the game processing further comprises
in a case where the first parameter is less than a predetermined upper limit value, and if an object in the first classification in the first state and the third state is not present in the virtual space, continuously increasing the first parameter to the upper limit value.

27. The information processing system according to claim 15, wherein
the plurality of actions include:
a combined weapon generation action for integrating an object in the second classification with a weapon object, thereby generating a combined weapon object; and
a weapon attack action for making an attack using the weapon object or the combined weapon object, and
the game processing further comprises
if the weapon attack action using the combined weapon object including an object in the first classification is performed, decreasing the first parameter by a predetermined amount.

28. The information processing system according to claim 15, wherein
the game processing further comprises:
controlling a non-player character in the in the virtual space; and
if the non-player character uses an object in the first classification in the third state, setting the object in the first classification to the fourth state.

29. An information processing method executed by one or more processors, the information processing method comprising:
based on operation data, controlling a player character in accordance with any of behaviors at least including a plurality of actions and a movement in a virtual space;
placing a plurality of objects in a first classification in the virtual space, each object having at least:
information indicating in which state of a first state and a second state other than the first state the object is;
information indicating in which state of a third state and a fourth state other than the third state the object is;
a type; and
a consumption amount for a first parameter associated with a player;
based on at least any of the actions, switching the first state and the second state of at least any of the objects in the first classification;
based on at least any of the actions, changing at least any of the objects in the first classification in the fourth state to the third state;
causing each of the objects in the first classification in the first state to continuously perform a behavior set with respect to each of the types in the virtual space;
based on the consumption amount of each of the objects in the first classification in the first state and the third state, continuously decreasing the first parameter; and
if the first parameter decreases to a predetermined reference, changing the object in the first classification in the first state and the third state from the first state to the second state.

30. The information processing method according to claim 29, wherein
the plurality of actions include an attack action, and
the information processing method further comprises
if the attack action hits an object in the first classification, switching the first state and the second state of the object in the first classification, and further, if the object in the first classification is in the fourth state, changing the object in the first classification to the third state.

31. The information processing method according to claim 29, wherein
the plurality of actions includes an object operation action for, using as a control target an object specified among objects in a second classification that is a classification at least including an object in the first classification, at least controlling a movement of the control target, and
the information processing method further comprises in a case where the player character performs the object operation action on the object in the first classification as the control target, and if the control target is in the fourth state, changing the control target to the third state.

32. The information processing method according to claim 31, further comprising
performing integration control for integrating the control target with another object in the second classification in the object operation action, thereby generating an assembly object, and if an object in the fourth state is included in an integration destination, changing the object in the fourth state to the third state.

33. The information processing method according to claim 32, further comprising
if the control target is an object in the first classification, and the integration destination is another object in the first classification or the assembly object including the other object in the first classification in the integration control in the object operation action, setting the information regarding the control target indicating in which state of the first state and the second state the control target is in to be the same as the information regarding an object in the first classification included in the integration destination.

34. The information processing method according to claim 33, wherein
the plurality of actions include an attack action, and
the information processing method further comprises
if the attack action hits the assembly object, switch the first state and the second state of all objects in the first classification included in the assembly object, and if an object in the fourth state is included in the assembly object, changing the object in the fourth state to the third state.

35. An information processing apparatus comprising:
one or more processors that execute game processing comprising:
based on operation data, controlling a player character in accordance with any of behaviors at least including a plurality of actions and a movement in a virtual space;
placing a plurality of objects in a first classification in the virtual space, each object having at least:
information indicating in which state of a first state and a second state other than the first state the object is;
information indicating in which state of a third state and a fourth state other than the third state the object is;
a type; and
a consumption amount for a first parameter associated with a player;
based on at least any of the actions, switching the first state and the second state of at least any of the objects in the first classification;
based on at least any of the actions, changing at least any of the objects in the first classification in the fourth state to the third state;
causing each of the objects in the first classification in the first state to continuously perform a behavior set with respect to each of the types in the virtual space;
based on the consumption amount of each of the objects in the first classification in the first state and the third state, continuously decreasing the first parameter; and
if the first parameter decreases to a predetermined reference, changing the object in the first classification in the first state and the third state from the first state to the second state.
